(19) United States
(12) Patent Application Publication
(10) Pub. No.: US 2013/0115413 A1
(43) Pub. Date: May 9, 2013

(54) FABRICATION AND USE OF ELEVATED OPTICAL NANOANTENNAS

(71) Applicant: UT-BATTELLE, LLC, Oak Ridge, TN (US)

(72) Inventors: Gyula Eres, Knoxville, TN (US); Baohua Gu, Oak Ridge, TN (US); Scott T. Retterer, Knoxville, TN (US); Zhenyu Zhang, Oak Ridge, TN (US); Nahla A. Abu Hatab, Knoxville, TN (US)

(73) Assignee: UT-BATTELLE, LLC, Oak Ridge, TN (US)

(21) Appl. No.: 13/670,772

(22) Filed: Nov. 7, 2012

Related U.S. Application Data
(60) Provisional application No. 61/556,863, filed on Nov. 8, 2011.

(51) Int. Cl. G01N 21/01

(52) U.S. Cl. CPC G01N 21/01; B82Y 20/00
USPC 428/120; 216/11; 977/700; 977/932

(57) ABSTRACT

A nanostructure including a pair of pointed metallic tips in proximity to each other. The pair of pointed metallic tips protrudes from a planar top surface of a substrate by a pair of pillar structures. The pair of pointed metallic tips can enhance optical scattering of materials placed therebetween through plasmonic electromagnetic field effects induced by the proximity of the pair of pointed metallic tips. Perturbation or interference from the substrate can be minimized through the increased distance from the substrate. The pair of pointed metallic tips can be formed by patterning a pair of adhesion material portions on a substrate, by vertically and laterally recessing regions that are not covered by the adhesion material portions, and by depositing a metal on the pair of adhesion material portions.

### RELATED APPLICATIONS

This application claims the benefit of priority from U.S. Provisional Application Ser. No. 61/556,863 filed on Nov. 8, 2011.

### STATEMENT REGARDING FEDERALLY SPONSORED RESEARCH OR DEVELOPMENT

This disclosure was made with United States government support under Prime Contract No. DE-AC05-00OR22725 awarded by the U.S. Department of Energy. The United States government has certain rights in this disclosure.

### FIELD OF THE DISCLOSURE

The present disclosure relates to the nanostructures, and particularly to a narrow gap elevated nanostructure for increasing sensitivity of surface enhanced Raman spectroscopy (SERS) and for applications in optoelectronic devices, and methods for manufacturing the same.

### BACKGROUND OF THE DISCLOSURE

The extreme sensitivity of Surface Enhanced Raman Spectroscopy (SERS) is dominated by the electromagnetic (K) enhancement, referring to the intense, spatially varying E fields produced by plasmonic coupling between closely spaced metal nanoparticles. A particularly intriguing feature of the electromagnetic enhancement is associated with the presence of the so-called “nanogap” effect where local SERS enhancement factors (EF) sufficient for detection of single molecules have been observed. Theoretical analysis using model systems consisting of closely spaced metal nanostructures have identified the size, shape, gap distance, the wavelength and polarization of the incident light as key factors that govern the overall EF within the nanogap. These advances in understanding the nanogap effect motivated new experimental approaches that, instead of searching for isolated hot spots or nanogaps in random nanoparticle aggregates, use electron beam lithography (EBL) fabricated periodic nanostructures.

EBL is a tool capable of fabricating SERS substrates with precisely defined shape and systematically variable nanogap size necessary for gaining insight into the underlying enhancement mechanisms and for achieving maximal enhancement. Recent compelling examples include the demonstration of a strong polarization and gap size dependent response from single gold nanobowties fabricated by EBL, and the high harmonic generation by resonant plasmon field enhancement from a closely packed gold bowtie arrays. However, until now, the large enhancement factors expected to occur for gap sizes on the order of a few nanometers remain difficult to confirm primarily because the resolution necessary for generating such features is beyond the capabilities of conventional EBL.

Overcoming these technical hurdles promises advances in fundamental understanding of gap dependent E field coupling that enable design and fabrication of a new generation of nanostructures that are capable of reliably and reproducibly performing single molecule detection and spectroscopy, and advanced optoelectronic functionality.

### SUMMARY OF THE DISCLOSURE

A nanostructure including a pair of pointed metallic tips in proximity to each other. The pair of pointed metallic tips protrudes from a planar top surface of a substrate by a pair of pillar structures. The pair of pointed metallic tips can enhance optical scattering from materials placed therebetween through plasmonic electromagnetic field effects induced by the proximity of the pair of pointed metallic tips. Perturbation or interference from the substrate can be minimized through the overhanging nanostructure or with increased distance from the substrate. The pair of pointed metallic tips can be formed by patterning a pair of adhesion material portions on a substrate, by vertically and laterally recessing regions that are not covered by the adhesion material portions, and by depositing a metal on the pair of adhesion material portions.

According to an aspect of the present disclosure, a structure is provided, which includes a first metallic pad having a first pointed tip, a first planar top surface, and a first planar bottom surface; a second metallic pad having a second pointed tip, a second planar top surface, and a second planar bottom surface, wherein the first pointed tip and the second pointed tip point at each other and spaced from each other by a dimension less than a maximum lateral dimension of the first and second metallic pads, wherein the substrate is vertically spaced from the first and second planar bottom surface; a first post located on, and above, the substrate and below the first metallic pad and providing mechanical support to the first metallic pad; and a second post located on, and above, the substrate and below the second metallic pad and providing mechanical support to the second metallic pad.

According to an aspect of the present disclosure, a method of forming a structure is provided. A first adhesion material portion and a second adhesion material portion are formed on a top surface of a substrate, wherein the first adhesion material portion has a first pointed tip and the second adhesion material portion has a second pointed tip. The first pointed tip and the second pointed tip point at each other and are spaced from each other by a dimension less than a maximum lateral dimension of the first and second adhesion material portions. Portions of the top surface of the substrate are recessed employing at least the first adhesion material portion and the second adhesion material portion as an etch mask. A first post contacting a bottom surface of the first adhesion material portion is formed from a remaining upper portion of the substrate and a second post contacting a bottom surface of the second adhesion material portion is formed from another remaining upper portion of the substrate, and a recessed top surface of the substrate is vertically separated from the bottom surfaces of the first adhesion material portion and the second adhesion material portion. A metal is deposited on a top surface of the first adhesion material portion and on a top surface of the second adhesion material portion. A first metallic pad is formed on the top surface of the first adhesion material portion and a second metallic pad is formed on the top surface of the second adhesion material portion.

### BRIEF DESCRIPTION OF THE DRAWINGS

FIG. 1A is a top-down view of an exemplary structure after application and patterning of a photoresist layer according to an embodiment of the present disclosure.

FIG. 1B is a vertical cross-sectional view of the exemplary structure of FIG. 1A.

FIG. 2A is a top-down view of the exemplary structure after deposition of adhesion material portions according to an embodiment of the present disclosure.

FIG. 2B is a vertical cross-sectional view of the exemplary structure of FIG. 2A.

FIG. 3A is a top-down view of the exemplary structure after a lift-off of the photoresist layer according to an embodiment of the present disclosure.

FIG. 3B is a vertical cross-sectional view of the exemplary structure of FIG. 3B.

FIG. 4A is a top-down view of the exemplary structure after vertical recessing of a substrate according to an embodiment of the present disclosure.

FIG. 4B is a vertical cross-sectional view of the exemplary structure of FIG. 4A.

FIG. 5A is a top-down view of the exemplary structure after an isotropic expansion of recesses within the substrate according to an embodiment of the present disclosure.

FIG. 5B is a vertical cross-sectional view of the exemplary structure of FIG. 5A.

FIG. 5C is a schematic top-down view of the exemplary structure of FIGS. 5A and 5B in which the sidewalls of the first and second posts are illustrated with dotted lines.

FIG. 6A is a top-down view of the exemplary structure after deposition of metal portions according to an embodiment of the present disclosure.

FIG. 6B is a vertical cross-sectional view of the exemplary structure of FIG. 6A.

FIG. 7A is a top-down view of the exemplary structure after removal of metal portions from the recessed surface of the substrate according to an embodiment of the present disclosure.

FIG. 7B is a vertical cross-sectional view of the exemplary structure of FIG. 7A.

FIG. 8A is a vertical cross-sectional view of a first variation of the exemplary structure after application and patterning of a photoresist layer according to an embodiment of the present disclosure.

FIG. 8B is a vertical cross-sectional view of the first variation of the exemplary structure after removal of metal portions from the recessed surface of the substrate according to an embodiment of the present disclosure.

FIG. 9A is a top-down view of a second variation of the exemplary structure after removal of metal portions from the recessed surface of the substrate according to an embodiment of the present disclosure.

FIG. 9B is a vertical cross-sectional view of the second variation of the exemplary structure of FIG. 9A.

FIG. 10A is a schematic illustration (not to scale) of the top view of a bowtie structure in the x-y plane (a horizontal plane).

FIG. 10B is a vertical cross-sectional view of the exemplary structure during surface enhanced Raman spectroscopy with a layer of pMA on a pair of pointed metallic structures.

FIG. 11 is a schematic illustration of elevated gold bowties on top of Si posts (e.g., elevated or suspended noble metallic nanostructures) etched into a Si wafer with Cr adhesion material portions between the gold layer and the Si post.

FIG. 12 is a side view of scanning electron micrograph (SEM) image of a three-dimensional gold bowtie nanoantenna with a gap of 8±1 nm.

FIG. 13 is a contour plot of the spatial distribution of the electromagnetic field intensity (E) calculated by finite difference time domain (FDTD) model simulations for bowtie equilateral triangle sides of 100 nm, gap size of 10 nm, Si posts of 40 nm in diameter and 200 nm in height, and an apex width of 10 nm. The intensity is represented by a logarithmic scale shown to the right.

FIG. 14 is a graph that shows a comparison of SERS spectra of p-mercaptoaniline (pMA) from elevated bowtie array substrates (labeled “With post”) and non-elevated bowtie array substrates (labeled “No post”).

FIG. 15 shows scanning electron micrograph (SEM) images of three elevated gold bowtie arrays (I, II, and III) with varying center-to-center distance (ccd) in rows along the bowtie axis, and varying row-to-row distance (rrd).

FIG. 16 is a log-log plot of SERS enhancement factors as a function of bowtie nanogap size in arrays I, II, and III of FIG. 15 with different bowtie spacing. The gap size dependence and the long range collective plasmonic effects in SERS enhancement using elevated gold bowtie nanoantenna arrays can be determined. The slope m in the log-log plot is determined by fitting the power-law relationship of EF∝Ad^{m} to the experimental data.

FIG. 17 shows an SEM image of bowtie arrays using a backscattered electron detector. The technique is used to distinguish heavy element gold (white triangles) from light element Si (gray posts).

FIG. 18 shows typical SERS spectra of pMA (baseline corrected) with the laser polarization set parallel and perpendicular to the bowtie axis. The spectra show the three dominant Raman modes at 390 cm⁻¹, 1077 cm⁻¹, and 1588 cm⁻¹.

FIG. 19 shows SERS spectra of pMA (baseline offset but not corrected) obtained from 13 different spots on a 1600 μm² bowtie array with an estimated standard error of ±12% for the integrated band area at 1588 cm⁻¹.

FIG. 20 is a graph comparing model-calculated maximum field |E|⁴ enhancement (dashed lines with open symbols) for apex widths w=1 nm, 5 nm, and 20 nm with the experimentally determined SERS enhancement (solid line with solid diamonds) as a function of nanogap size for elevated bowtie arrays with ccd=rrd=300 nm (corresponding to SEM image III in FIG. 15). The slope is determined by fitting the power-law relationship of |E|⁴=Ad^{m} to the data.

FIG. 21 is the calculated maximum field enhancement |E|⁴ normalized by that without the Si post as a function of the post height showing the characteristics of nanocavity resonance.

FIG. 22 is the maximum field enhancement |E|⁴ calculated by finite difference time domain (FDTD) as a function of the product of the apex width and the gap size, w×d, for varying apex widths of a truncated tip. The open symbols are FDTD data and the lines are the power-law fit. The inter-bowtie distances are ccd=rrd=300 nm. The diameter of the Si posts is 40 nm, and the height is 200 nm. The calculated slope falls in a narrow range of about −2.5.

FIG. 23 is a top-view of an SEM image of the elevated gold bowtie arrays used as surface enhanced Raman scattering (SERS) substrates. The inset is an enlarged, tilted view of a gold bowtie array sitting on the top of silicon posts.

FIG. 24 illustrates detection and spectral analysis of an environmental pollutant, perchlorate (ClO₄⁻), at varying concentrations using a portable Raman sensor.

FIG. 25 is a log-log plot of the peak intensity at 947 cm⁻¹ as a function of the ClO₄⁻ concentration.

FIG. 26 illustrates SERS determination of ClO₄⁻ in a contaminated groundwater sample (GWOBODO3) by the standard addition method. SERS spectra with the addition of varying concentrations of ClO₄⁻ at (a) 0, (b) 0.01, (c) 0.03, (d) 0.04, (e) 0.07, and (f) 0.12 mM are shown.

FIG. 27 shows a calibration curve for determining the actual ClO₄⁻ concentration in groundwater.

FIG. 28 illustrates SERS determination of trinitrotoluene (TNT) in a contaminated groundwater sample by the standard addition method. SERS spectra with the addition of varying concentrations of TNT standards at (a) 0, (b) 1.6, (c) 2.3, (d) 5.5, (e) 9.3, and (f) 14.0 μM are shown.

FIG. 29 shows a calibration curve for determining the actual TNT concentration in groundwater.

### DETAILED DESCRIPTION OF THE DISCLOSURE

As stated above, the present disclosure relates to nanoarrays containing elevated or suspended metallic nanostructures on a substrate, and methods for fabrication thereof. Aspects of the present disclosure are now described in detail with accompanying figures. It is noted that like reference numerals refer to like elements across different embodiments. The drawings are not necessarily drawn to scale.

An exemplary structure according to an embodiment of the present disclosure can be formed as nanoarrays. As used herein, a “nanoarray” refers to an array of a unit structure having at least one nanoscale dimension. As used herein, a “nanoscale gap size” refers to a gap size less than 50 nm. As used herein, a “nanoscale gap” refers to a gap having a nanoscale gap size.

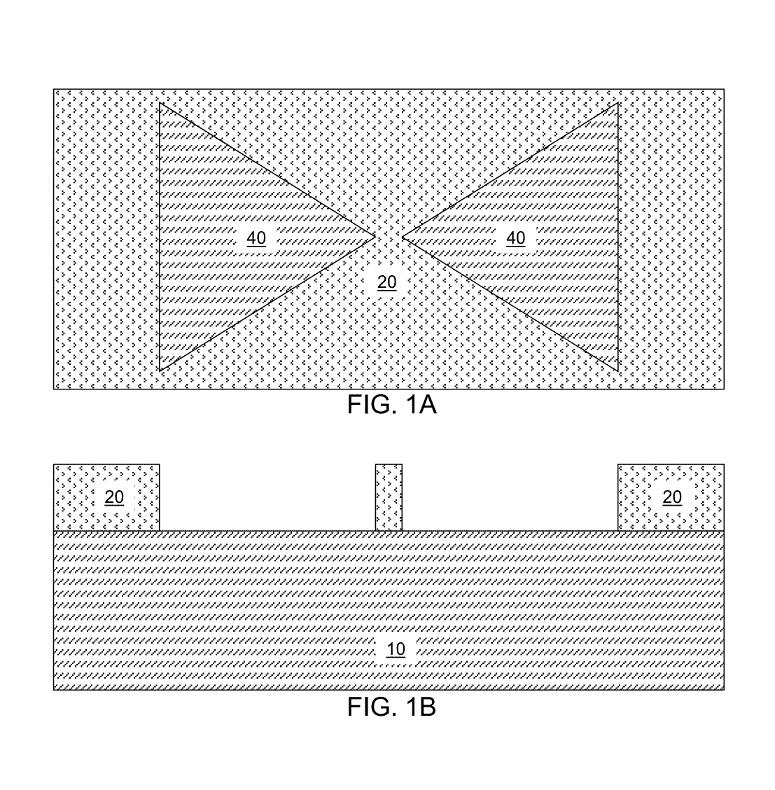

Referring to FIGS. 1A and 1B, an exemplary structure according to an embodiment of the present disclosure is shown, which includes a substrate 10. In one embodiment, the substrate 10 can include a semiconductor material and/or a dielectric material. Materials that can be employed for the substrate 10 include, but are not limited to, silicon, silicon dioxide (SiO₂), glass, germanium, and titanium oxides. The substrate 10 can have a planar top surface.

A photoresist layer 20 is applied over the planar top surface of the substrate 10. For example, the photoresist layer 20 can be a layer of e-beam resist, which is spun on the substrate 10 as a blanket layer, and is subsequently baked for the purpose of hardening. Subsequently, the photoresist layer 20 is patterned by lithographic means. In case the photoresist layer 20 includes an e-beam resist, the photoresist layer 20 can be patterned at an acceleration voltage in the range of 30 to 100 kV. The thickness of the photoresist layer 20 can be from 1 nm to 5,000 nm, although lesser and greater thicknesses can also be employed.

After lithographic exposure, the photoresist layer 20 is typically developed in a hydrocarbon solution including xylene, benzene, and/or toluene. The material of the photoresist layer 20 can be rinsed in an alcohol solution, which can be, for example, ethyl alcohol, isopropyl alcohol, and/or butanol. The photoresist layer 20 can be dried under an inert gas, such as for example, nitrogen or argon. In one embodiment, the photoresist layer 20 can be developed in xylene, rinsed in isopropyl alcohol, and subsequently dried under a stream of nitrogen. Following development, the substrate 10 can be exposed to oxygen plasma to clean residual photoresist materials.

At least one pair of openings is formed in the patterned photoresist layer 20. In one embodiment, openings in the photoresist layer 20 can be formed as a two-dimensional array of a unit pattern that includes a pair of openings.

The pair of openings in the unit pattern in the patterned photoresist layer 20 can be in any shape and in any size. The size of each opening can be characterized by a lateral dimension. For the purposes of the present disclosure, the lateral dimension can be a diameter of a circular shape, the longest length of a triangle, or the longest side of a quadrangle. For example, the pair of openings in the unit pattern can have a pair of mirror-image triangles, a pair of mirror image ellipses, or a pair of mirror image quadrangles. In case the pair of openings in the unit pattern includes a pair of isolateral triangles or a pair of isosceles triangles having a base shorter than the two symmetric sides, the lateral dimension can be the length of a side of the isolateral triangles or the length of one of the symmetric sides. The pair of openings in the unit pattern may have minor symmetry around a plane passing through a center point of the unit pattern, and laterally spaced from each other by a lateral separation distance. As used herein, a “lateral separation distance” is the minimum lateral distance between two shapes. In one embodiment, the minimum for the lateral dimension can be about 5 nm, about 10 nm, about 100 nm, about 200 nm, or about 300 nm, and the maximum for the lateral dimension can be about 1,000 nm, about 900 nm, or about 800 nm.

The noble metal nanostructures in the nanoarray can be closely packed, or each pair of nanostructural arrays can be separated with a center-to-center lateral separation distance of 10 nm up to tens of micrometers. As used herein, the “center-to-center lateral separation distance” refers to a lateral distance from the geometrical center for the shape of one opening in the pair of openings to the geometrical center for the shape of the other opening in the pair of openings.

In one embodiment, the pair of openings in the unit pattern can include a pair of triangular shaped openings laterally spaced by a lateral separation distance. This configuration is herein referred to as a “bowtie” configuration. An array of pairs of shapes in which each pair of openings is in the bowtie configuration is herein referred to as a “bowtie array.”

The minimum lateral separation distance between a pair of openings (e.g., between tips of two triangles in a bowtie array) within the unit pattern can be about 1 nm, about 2 nm, or about 3 nm. The maximum lateral separation distance between a pair of openings (e.g., between tips of two triangles in a bowtie array) within the unit pattern can be about 1,000 nm, or about 500 nm, or about 300 nm, or about 200 nm, or about 100 nm. In one embodiment, the gap size or lateral separation distance is between 1 nm to 500 nm.

For example, in one embodiment, the center-to-center lateral separation distance of the bowtie nanoarray is approximately equal to the excitation laser incident frequency leading to maximal electromagnetic field resonance in surface enhanced Raman scattering set-up. For example, a center-to-center lateral separation distance of 785 nm of the bowtie nanoarray can be used when an incident laser of 785 nm is used for the excitation. In one embodiment, the center-to-center lateral separation distance of the bowtie nanoarray may be substantially the same as the wavelength of a laser beam employed for surface enhanced Raman scattering. In this case, the resolution of surface enhance Raman spectroscopy can be further enhanced through far field enhancement.

In one embodiment, a plurality of pairs of openings can be provided in the patterned photoresist layer 20. The plurality of pair of openings can constitute a two-dimensional array. In one embodiment, the two-dimensional array can be a periodic array having a first pitch along a first horizontal direction (e.g., an x-direction in a Cartesian coordinate system) and having a second pitch along a second horizontal direction (e.g., a y-direction in the Cartesian coordinate system). In one embodiment, each of the first pitch and the second pitch is in a range from 50 nm to 5,000 nm.

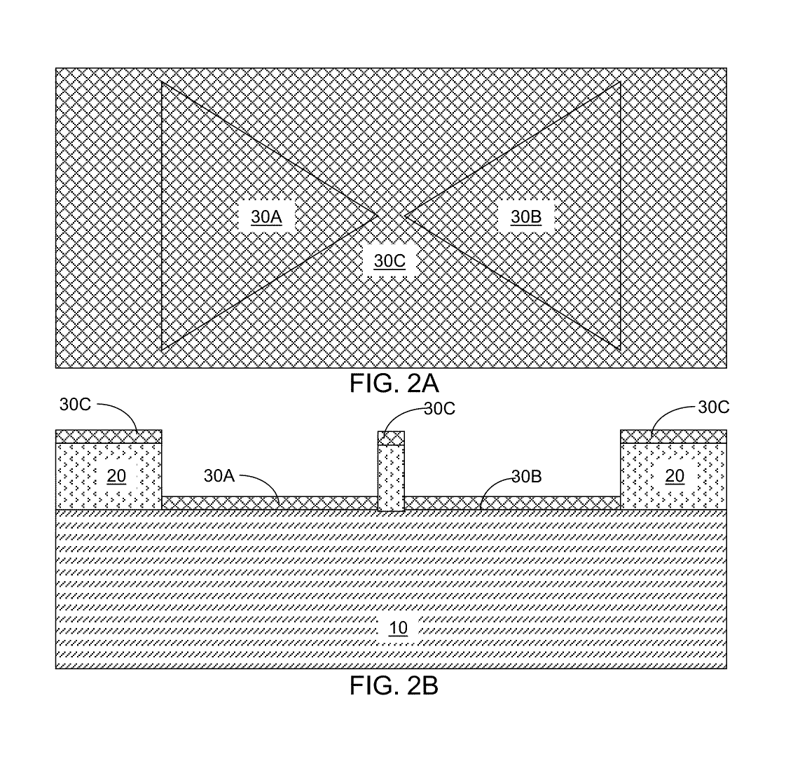

Referring to FIGS. 2A and 2B, adhesion material portions 30 are formed on physically exposed top surfaces of the substrate 10 and the photoresist layer 20. Within each unit pattern, a first adhesion material portion 30A and a second adhesion material portion 30B are formed on the top surface of the substrate 10. A contiguous adhesion material portion 30C is formed over the top surface of the patterned photoresist layer 20.

The adhesion material portions (30A, 30B, 30C) can be deposited by any method known to those in the art, including, but not limited to, vacuum evaporation and physical vapor deposition (PVD). For example, the adhesion material portions (30A, 30B) can be deposited using an electron-beam dual gun evaporation chamber equipped with a quartz crystal monitor to measure the thickness. In one embodiment, the adhesion material portions (30A, 30B, 30C) can be deposited by a directional deposition method in which the deposited material impinges on the physically exposed surfaces of the substrate 10 and the patterned photoresist layer 20 in a direction substantially normal to the physically exposed surfaces of the substrate 10 and the patterned photoresist layer 20. In one embodiment, the first and second adhesion material portions (30A, 30B) can be physically disjoined from the contiguous adhesion material portion 30C located on the top surface of the patterned photoresist layer 20.

In one embodiment, the adhesion material portions (30A, 30B, 30C) include a material to which noble metals can adhere to. Examples of suitable materials that can be deposited to form the adhesion material portions (30A, 30B, 30C) include, for instance, chromium, titanium, tantalum, titanium nitride, and tantalum nitride. The thickness of each adhesion material portions (30A, 30B, 30C) can be greater than 1 nm, or 2 nm, or 3 nm, or 5 nm, or 10 nm, or 20 nm, and can be lesser than 50 nm, or 40 nm, or 30 nm, or 20 nm, or 10 nm, although lesser and greater thicknesses can also be employed.

The first and second adhesion material portions (30A, 30B) has the same shape as the shape of the pair of openings in the unit pattern of the patterned photoresist layer 20. Thus, all lateral dimensions of the first and second adhesion material portions (30A, 30B) are identical to the corresponding lateral dimensions in the pair of openings in the unit pattern of the patterned photoresist layer 20. In one embodiment, the first adhesion material portion 30A has a first pointed tip and the second adhesion material portion 30B has a second pointed tip. As used herein, a “pointed tip” refers to geometry of a physical structure for which there exists a point such that a width of the physical structure decreases strictly with any decrease of a distance to the point. It is understood that the width is measured along a same direction. As used herein, a first parameter “decreases strictly” with a specified type of change in a second parameter if the value of the first parameter becomes less for any of the specified type of change. The first pointed tip and the second pointed tip can point at each other, and can be spaced from each other by a dimension less than a maximum lateral dimension of the first and second adhesion material portions (30A, 30B).

In one embodiment, the first adhesion material portion 30A can have a first generally triangular horizontal cross-sectional shape, and the first pointed tip can be located at an apex of the first generally triangular horizontal cross-sectional shape. The second adhesion material portion 30B can have a second generally triangular horizontal cross-sectional shape, and the second pointed tip can be located at an apex of the second generally triangular horizontal cross-sectional shape. As used herein, a shape is “generally triangular” if the shape can be approximated with a triangle such that the deviation of all peripheries of the shape does not deviate from the triangle by more than 10% of the shortest edges of the triangle.

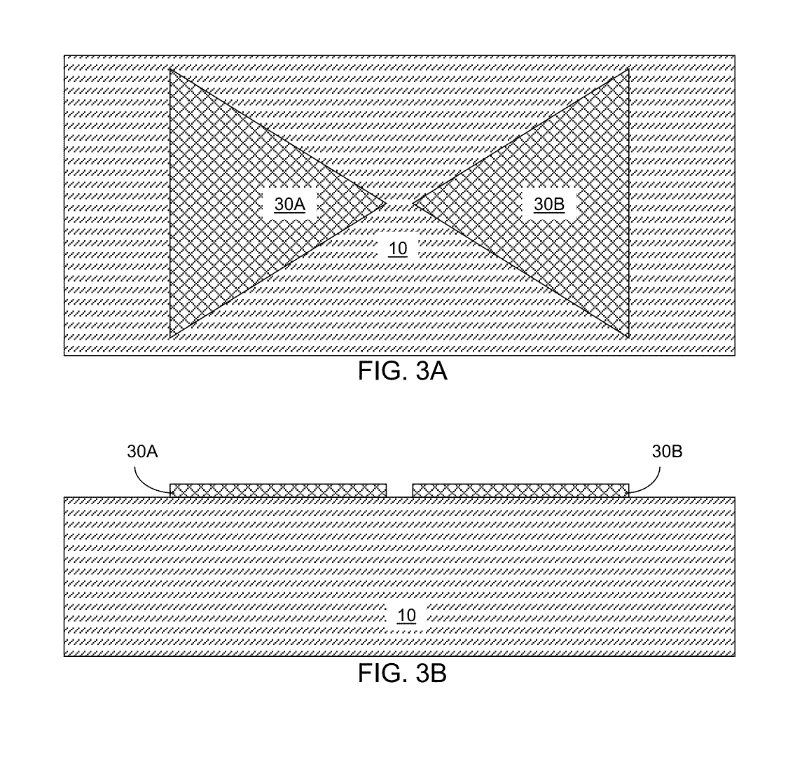

Referring to FIGS. 3A and 3B, the patterned photoresist layer 20 and the contiguous adhesion material portion 30C can be removed by any method known to those in the art. For example, the patterned photoresist layer 20 and the contiguous adhesion material portion 30C can be removed by lift-off using an acetone bath followed by an alcohol solution rinse. Suitable alcohol solutions include those described above. Optionally, following the lift-off process, the physically exposed surface of the substrate 10 and the pair of first and second adhesion material portions (30A, 30B) in each unit pattern can be dried under an inert gas. Such inert gases include those described above.

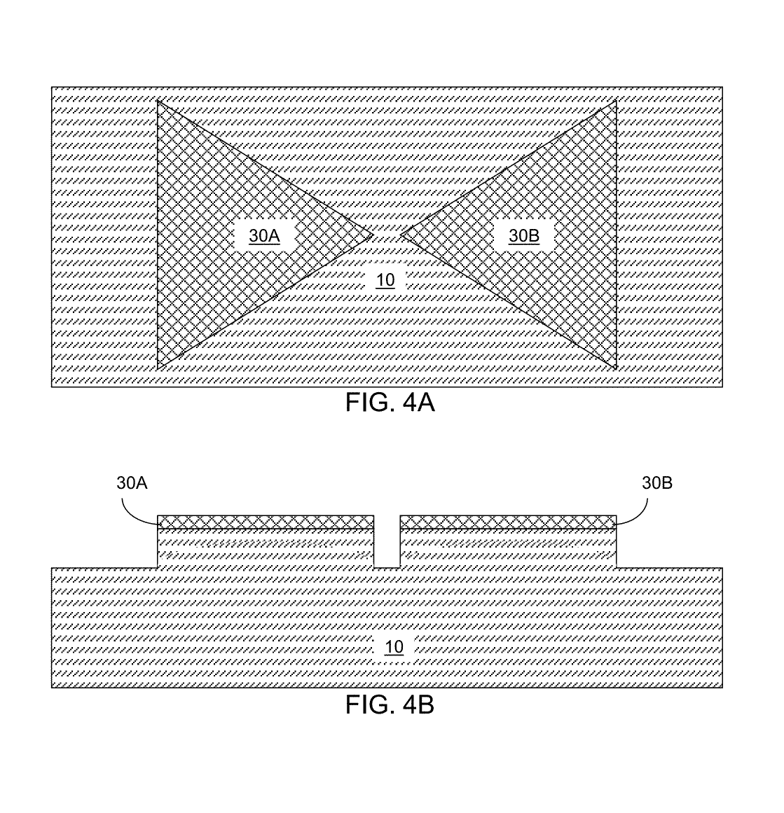

Referring to FIGS. 4A and 4B, physically exposed portions of the top surface of the substrate 10 are recessed employing the first adhesion material portion 30A and the second adhesion material portion 30B in each unit pattern as an etch mask. If an array of unit patterns is provided on the substrate 10, a plurality of first adhesion material portions 30A and a plurality of second adhesion material portions 30B within the array can be collectively employed as an etch mask.

In one embodiment, an etching system can be used to etch the physically exposed portions of the substrate 10. Any suitable etching system known to those skilled in the art can be utilized. An example of a suitable etching system is reactive ion etching system.

In one embodiment, the physically exposed portions of the top surface of the substrate 10 can be vertically recessed by an anisotropic etch that employs the first adhesion material portion 30A and the second adhesion material portion 30B in each unit pattern as an etch mask. In one embodiment, vertical sidewalls that are vertically coincident with sidewalls of the first and second adhesion material portions (30A, 30B) can be formed on the substrate 10 below the interface between the substrate 10 and the first and second adhesion material portions (30A, 30B).

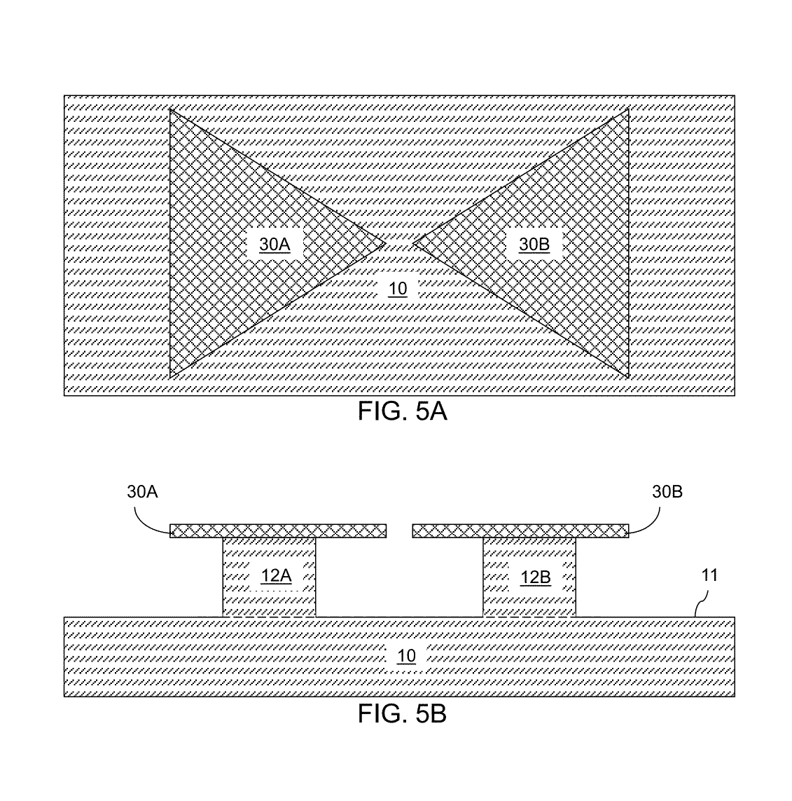

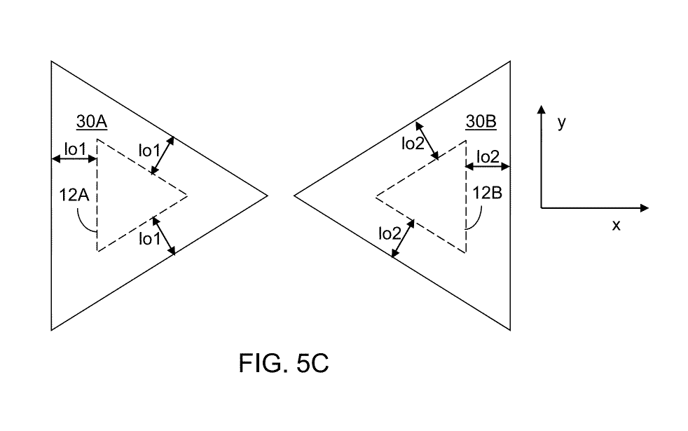

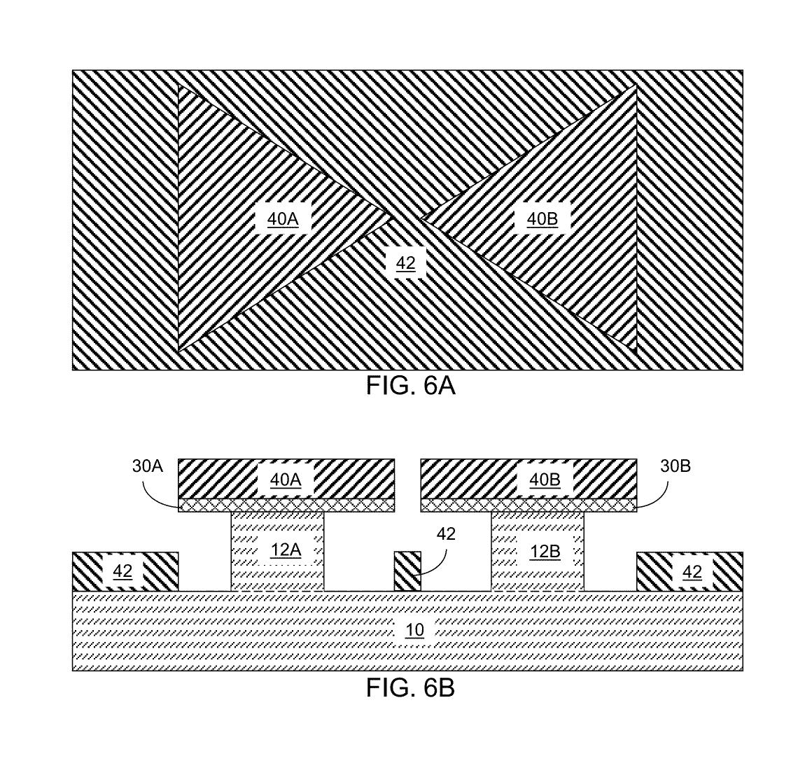

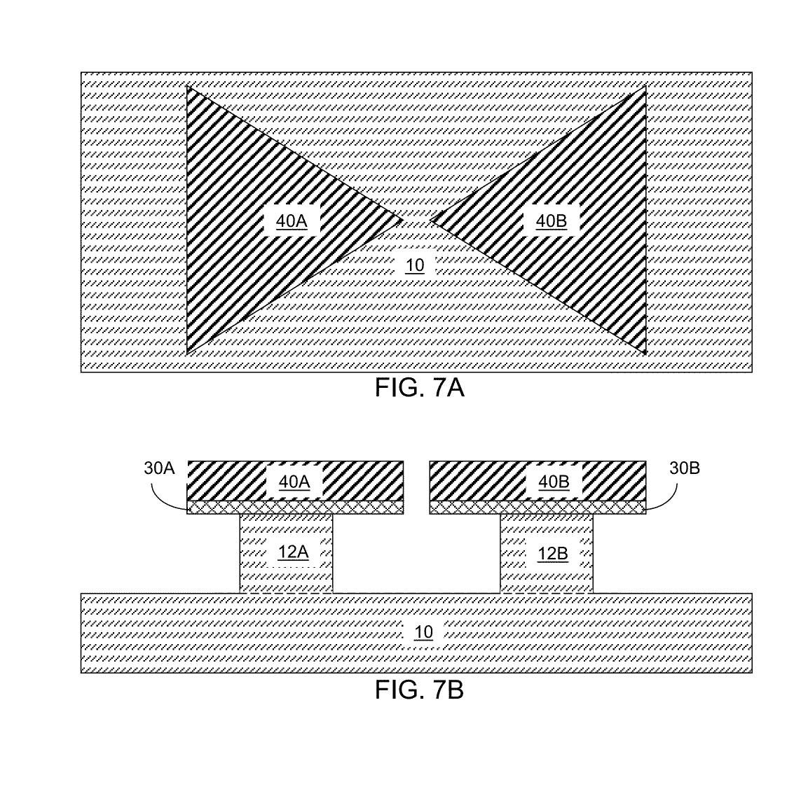

Referring to FIGS. 5A, 5B, and 5C, the recesses within the substrate 10 can be isotropically expanded laterally and vertically employing an isotropic etch. The isotropic etch can be a wet etch or a dry etch. If the substrate 10, the first post 12A, and the second post 12B include silicon, the isotropic etch can be a wet etch employing a KOH solution. If the substrate 10, the first post 12A, and the second post 12B include silicon oxide, the isotropic etch can be a wet etch employing hydrofluoric acid.

A material of the substrate 10 is etched from underneath peripheral portions of the first adhesion material portion 30A and from underneath peripheral portions of the second adhesion material portion 30B. A first post 12A contacting a bottom surface of the first adhesion material portion 30A is formed from a remaining upper portion of the substrate 10, and a second post 12B contacting a bottom surface of the second adhesion material portion 30B is formed from another remaining upper portion of the substrate 10. A recessed top surface 11 of the substrate 10 is vertically separated from the bottom surfaces of the first adhesion material portion 30A and the second adhesion material portion 30B. After the etch, peripheral portions of the first adhesion material portion 30A extend farther outward than sidewalls of the first post 12A, and peripheral portions of the second adhesion material portion 30B extend farther outward than sidewalls of the second post 12B.

Sidewalls of the first post 12A can be laterally recessed from sidewalls of the first adhesion material portion 30A by a first lateral offset distance lo1, and sidewalls of the second post 12B can be laterally recessed from sidewalls of the second adhesion material portion 30B by a second lateral offset distance lo2. In one embodiment, the first lateral offset distance lo1 and the second lateral offset distance lo2 can be the same as measured at a same horizontal plane that intersects the first and second posts (12A, 12B) and located at the bottommost surfaces of the first and second adhesion material portions (30A, 30B) and the recessed top surface 11 of the substrate 10.

In one embodiment, the minimum height of the posts (12A, 12B) can be about 10 nm, about 100 nm, about 200 nm, or about 300 nm, and the maximum height of the posts (12A, 12B) can be generally about 1000 nm, about 900 nm, or about 800 nm. In one embodiment, the height of the posts (12A, 12B) can be selected depending on the lateral size of the feature. The height of the posts (12A, 12B) can be less than ½ of the lateral dimension of the adhesion material portions (30A, 30B).

While an embodiment in which two separate etches is described herein, embodiments in which a single etch process includes an anisotropic etch component and an isotropic etch component can also be employed.

Referring to FIGS. 6A and 6B, a metal is deposited on the top surfaces of the first and second adhesion material portions (30A, 30B) to form a first metallic pad 40A and a second metallic pad 40B, respectively. As used herein, a “metal” refers to an elemental metal or an intermetallic alloy of at least two elemental metals. The first metallic pad 40A is formed on the top surface of the first adhesion material portion 30A, and the second metallic pad 40B is formed on the top surface of the second adhesion material portion 30B. The first metallic pad 40A and the second metallic pad 40B can be formed by a directional deposition of at least one metal along a direction that is perpendicular to the interface between the first and second adhesion material portions (30A, 30B) and the first and second posts (12A, 12B).

The at least one metal that is deposited on the top surfaces of the first and second adhesion material portions (30A, 30B) can be an elemental transition metal, an elemental rare earth metal, or a combination or an alloy thereof. In one embodiment, the at least one metal that is deposited on the top surfaces of the first and second adhesion material portions (30A, 30B) can include at least one noble metal. In another embodiment, the at least one metal that is deposited on the top surfaces of the first and second adhesion material portions (30A, 30B) can consist essentially of at least one noble metal. In yet another embodiment, the at least one metal that is deposited on the top surfaces of the first and second adhesion material portions (30A, 30B) can consist essentially of a single elemental noble metal.

As used herein, a noble metal refers to gold, silver, platinum, ruthenium, rhodium, palladium, osmium, and iridium. Noble metals are generally resistant to corrosion and oxidation. Each pair of a first stack of a first post 12A, a first adhesion material portion 30A, and a first metallic pad 40A and a second stack of a second post 12B, a second adhesion material portion 30B, and a second metallic pad 40B can constitute a unit nanostructure (12A, 30A, 40A, 12B, 30B, 40B). A plurality of unit nanostructures can be arranged in an array pattern on the substrate 10. Each stack of a first adhesion material portion 30A and a first metallic pad 40A is elevated from the substrate 10 via a first post 12A, and is suspended over the substrate 10 by the first post 12A. Each stack of a second adhesion material portion 30B and a second metallic pad 40B is elevated from the substrate 10 via a second post 12B, and is suspended over the substrate 10 by the second post 12B.

The first metallic pad 40A can be formed with a first horizontal cross-sectional shape that is substantially the same as a horizontal cross-sectional shape of the first adhesion material portion 30A, and the second metallic pad 40B can be formed with a second horizontal cross-sectional shape that is substantially the same as a horizontal cross-sectional shape of the second adhesion material portion 30B. In one embodiment, each of the first metallic pad 40A and the second metallic pad 40B can be formed with a substantially same horizontal cross-sectional area between a topmost surface thereof and a bottommost surface thereof. The first metallic pad 40A and the second metallic pad 40B can be formed with a same composition and with a same thickness. The thickness of the first metallic pad 40A and the second metallic pad 40B can be greater than 5 nm, or 10 nm, or 20 nm, or 30 nm, and can be lesser than 200 nm, or 100 nm, or 50 nm, although lesser and greater thickness can also be employed.

A pair of a triangle-shaped stack of a first adhesion material portion 30A and a first metallic pad 40A and a triangle-shaped stack of a second adhesion material portion 30B and a second metallic pad 40B is herein referred to as “elevated bowties.” A metal layer 42 including the metal is deposited on the recessed top surface of the substrate 10 concurrently with the deposition of the metal on the top surface of the first adhesion material portion 30A and on the top surface of the second adhesion material portion 30B. The adhesion between the metal layer 42L and the recessed surface of the substrate 10 is weak because an adhesion material potion is not present between the metal layer 42L and the recessed surface of the substrate 10.

Referring to FIGS. 7A and 7B, the metal layer 42 is removed from the recessed surface of the substrate 10, for example, by washing in a solution. Thus, the metal layer 42 is removed selective to the first metallic pad 40A and the second metallic pad 40B. Each unit pattern in a two-dimensional array of unit patterns can include a first metallic pad 40A and a second metallic pad 40B. The first metallic pad 40A has a first pointed tip, a first planar top surface, and a first planar bottom surface. The second metallic pad 40B has a second pointed tip, a second planar top surface, and a second planar bottom surface. The first pointed tip and the second pointed tip point at each other, and are spaced from each other by a dimension less than a maximum lateral dimension of the first and second metallic pads (40A, 40B). The substrate 10 is vertically spaced from the first and second planar bottom surface. A first post 12A is located on, and above, the substrate 10 and below the first metallic pad 40A, and provides mechanical support to the first metallic pad 40A. A second post 12B is located on, and above, the substrate 10 and below the second metallic pad 40B, and provides mechanical support to the second metallic pad 40B. The sidewalls of the first post 12A, the sidewalls of the second post 12B, and the recessed top surface of the substrate 10 can include a same material.

The first metallic pad 40A has a first generally triangular horizontal cross-sectional shape, and the first pointed tip is located at an apex of the first generally triangular horizontal cross-sectional shape. The second metallic pad 40B has a second generally triangular horizontal cross-sectional shape, and the second pointed tip is located at an apex of the second generally triangular horizontal cross-sectional shape. The first adhesion material portion 30A contacts a bottom surface of the first metallic pad 40A and contacts a top surface of the first post 12A. The second adhesion material portion 30B contacts a bottom surface of the second metallic pad 40B and contacts a top surface of the second post 12B. Peripheral portions of the first adhesion material portion 30A extend farther outward than sidewalls of the first post 12A, and peripheral portions of the second adhesion material portion 30B extend farther outward than sidewalls of the second post 12B.

In one embodiment, the first adhesion material portion 30A can have a horizontal cross-sectional shape that is substantially the same as a first horizontal cross-sectional shape of the first metallic pad 40A. The second adhesion material portion 30B can have a horizontal cross-sectional shape that is substantially the same as a second horizontal cross-sectional shape of the second metallic pad 40B.

In one embodiment, sidewalls of the first post 12A can be laterally recessed from sidewalls of the first adhesion material portion 30A by the first lateral offset distance lo1 (See FIG. 5C), and sidewalls of the second post 12B can be laterally recessed from sidewalls of the second adhesion material portion 30B by the second lateral offset distance lo2 (See FIG. 5C). The first lateral offset distance lo1 and the second lateral offset distance lo2 can be the same as measured at a same horizontal plane that intersects the first and second posts (12A, 12B).

In one embodiment, a lateral separation distance between the first pointed tip and the second pointed tip can be from 1 nm to 500 nm. In one embodiment, the first metallic pad 40A and the second metallic pad 40B can have the same composition and the same thickness, which can be can be greater than 5 nm, or 10 nm, or 20 nm, or 30 nm, and can be lesser than 200 nm, or 100 nm, or 50 nm, although lesser and greater thickness can also be employed.

The at least one unit nanostructure (12A, 30A, 40A, 12B, 30B, 40B) can be a plurality of unit structures arranged as a two-dimensional array on the substrate 10. The two-dimensional array is a periodic array having a first pitch along a first horizontal direction and having a second pitch along a second horizontal direction. Each of the first pitch and the second pitch is in a range from 50 nm to 5,000 nm. For example, each of the first pitch and the second pitch can be independently greater than 50 nm, or 100 nm, or 200 nm, or 500 nm, and can be lesser than 5,000 nm, or 3,000 nm, or 1,000 nm, or 500 nm, although lesser and greater thickness can also be employed.

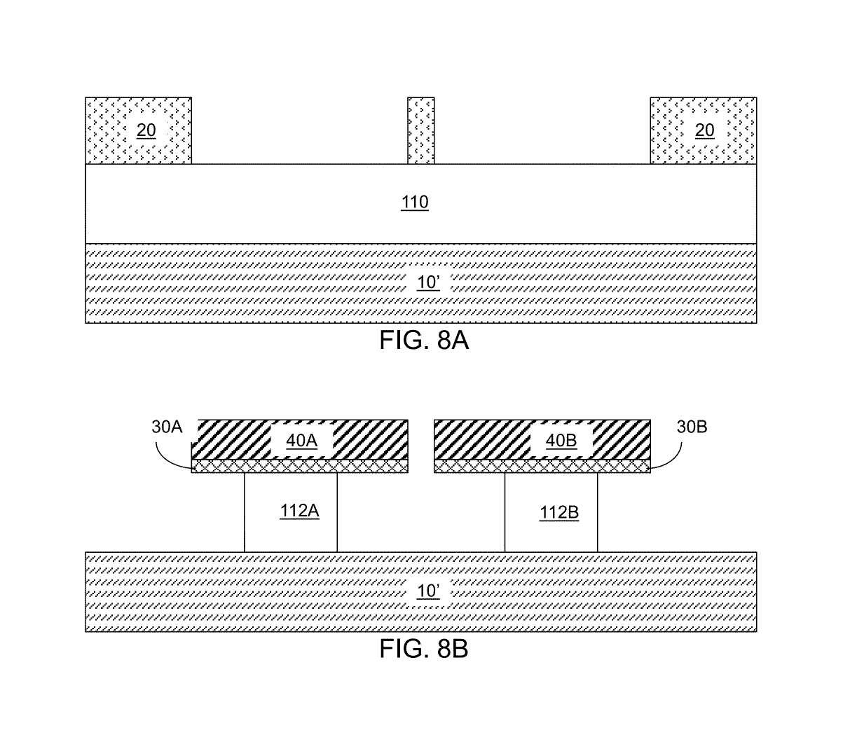

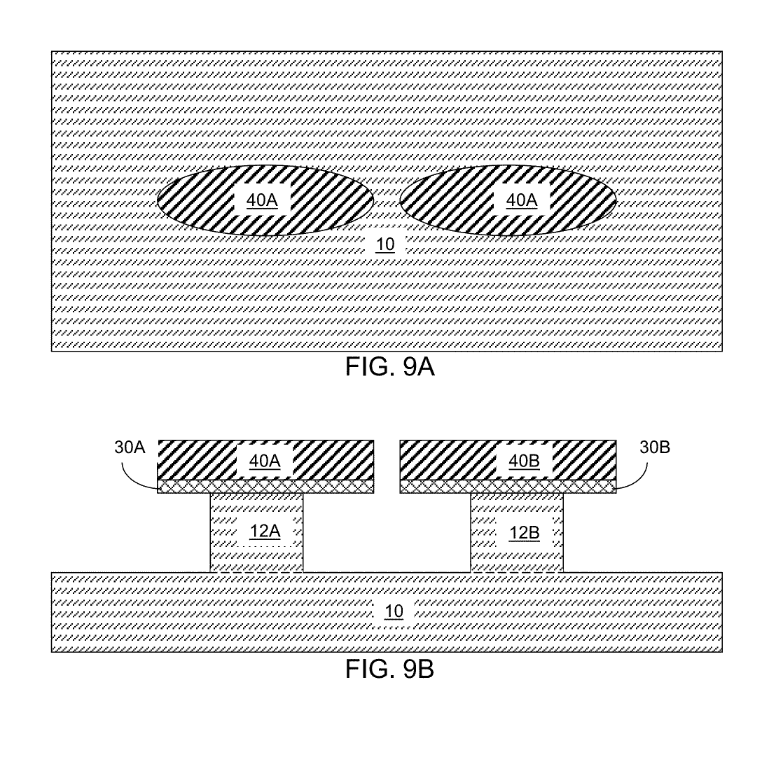

Referring to FIG. 8A, a first variation of the exemplary structure can be derived from the first exemplary structure by employing a substrate (10′, 110) including a vertical stack of a substrate layer 10′ and a post material layer 110 in lieu of the substrate 10 of the exemplary structure. The substrate layer 10′ can include a semiconductor material, an insulator material, or a conductive material. For example, the substrate layer 10′ can include a semiconductor material such as silicon. The post material layer 110 can include a semiconductor material or an insulator material. For example, the post material layer 110 can include silicon oxide. A photoresist layer 20 is applied on the surface of the substrate (10′, 110) and is lithographically patterned.

Referring to FIG. 8B, processing steps of FIGS. 2A, 2B, 3A, 3B, 4A, 4B, 5A, 5B, 5C, 6A, 6B, 7A, and 7B can be subsequently performed with modifications to the etch chemistry in the processing steps of FIGS. 4A, 4B, 5A, 5B, and 5C so as to etch the post material layer 110 instead of the substrate 10. A first post 112A is formed from a remaining portion of the post material layer 110, and a second post 112B is formed from another remaining portion of the post material layer 110.

The sidewalls of the first post 112A and the sidewalls of the second post 112B include a different material than the recessed top surface of the substrate, which includes only the substrate layer 10′ after formation of the first post 112A and the second post 112B. The first post 112A and the second post 112B can have a same composition, which is the composition of the post material layer 110 that is different from a composition of the substrate layer 10′.

Referring to FIGS. 9A and 9B, the pattern in the photoresist layer 20 can be modified to provide a second variation of the exemplary structure. Specifically, the triangular patterns for the first and second adhesion material portions (30A, 30B) can be replaced with generally elliptical patterns. As used herein, a shape is “generally elliptical” if the shape can be approximated with an ellipse such that the deviation of all peripheries of the shape does not deviate from the ellipse by more than 10% of the semimajor axis of the ellipse.

Each unit pattern in a two-dimensional array of unit patterns can include a first metallic pad 40A and a second metallic pad 40B. The first metallic pad 40A has a first pointed tip, a first planar top surface, and a first planar bottom surface. The second metallic pad 40B has a second pointed tip, a second planar top surface, and a second planar bottom surface. The first pointed tip and the second pointed tip point at each other, and are spaced from each other by a dimension less than a maximum lateral dimension of the first and second metallic pads (40A, 40B). The substrate 10 is vertically spaced from the first and second planar bottom surface. A first post 12A is located on, and above, the substrate 10 and below the first metallic pad 40A, and provides mechanical support to the first metallic pad 40A. A second post 12B is located on, and above, the substrate 10 and below the second metallic pad 40B, and provides mechanical support to the second metallic pad 40B. The sidewalls of the first post 12A, the sidewalls of the second post 12B, and the recessed top surface of the substrate 10 can include a same material.

In one embodiment, the first adhesion material portion 30A can have a first generally elliptical horizontal cross-sectional shape, and the first pointed tip can be located at a vertex on a major axis of the first generally elliptical horizontal cross-sectional shape. The second adhesion material portion 30B can have a second generally elliptical horizontal cross-sectional shape, and the second pointed tip can be located at a vertex on a major axis of the second generally elliptical horizontal cross-sectional shape.

In one embodiment, the first metallic pad 40A can have a first generally elliptical horizontal cross-sectional shape, and the first pointed tip can be located at a vertex on a major axis of the first generally elliptical horizontal cross-sectional shape. The second metallic pad 40B can have a second generally elliptical horizontal cross-sectional shape, and the second pointed tip can be located at a vertex on a major axis of the second generally elliptical horizontal cross-sectional shape.

In general, any shape can be employed for the first metallic pad 40A and the second metallic pad 40B provided that the first metallic pad 40A has a first pointed tip and the second metallic tip 40B has a second pointed tip, and the distance between the first pointed tip and the second pointed tip is less than 50 nm.

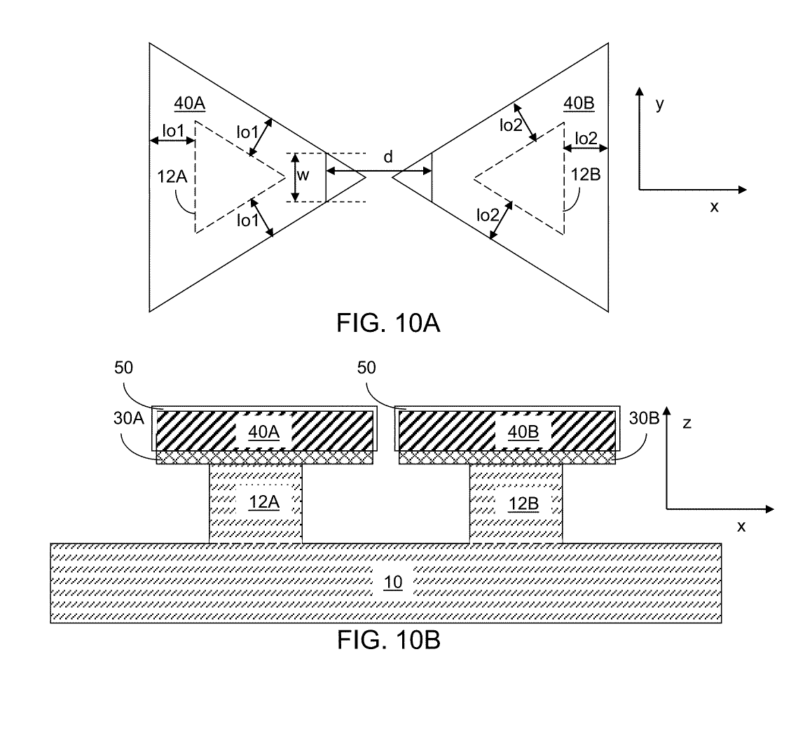

Referring to FIG. 10A, a schematic illustration (not to scale) of the top view of a bowtie structure in the x-y plane (a horizontal plane) is shown. In one embodiment, the actual shape of each of the first metallic pad 40A and the second metallic pad 40B may be approximated by a trapezoid having a shortest side corresponding to the first pointed tip or to the second pointed tip. In this approximation, a least square fitting method may be employed to identify a trapezoid that provides the best fit to the periphery of the first metallic pad 40A or to the periphery of the second metallic pad 40B. In one embodiment, the trapezoids that approximate a pair of a first metallic pad 40A and a second metallic pad 40B can be selected such that the shortest sides of each trapezoid are parallel to each other. In this case, the length of the shortest side of each trapezoid is herein referred to as a “width” w of a pointed tip of the corresponding metallic pad (40A or 40B). In one embodiment, a pair of the first metallic pad 40A and the second metallic pad 40B can be manufactured such that the widths w of the pointed tips of the first and second metallic pads (40A, 40B) are identical. The distance between the two shortest sides of the trapezoids that fit the peripheries of the first and second metallic pads (40A, 40B) is herein referred to as a “tip separation distance” d, a “separation distance,” or a “gap size.”

Referring to FIG. 10B, a chemical material layer 50 can be coated on physically exposed surfaces of the first metallic pad 40A and the second metallic pad 40B, for example, for the purpose of analyzing the composition of the chemical material layer 50 by surface enhanced Raman scattering (SERS) analysis. The chemical material layer 50 can be and adsorbed analyte layer.

For example, a layer of p-mercaptoaniline (pMA) can be coated as the chemical material layer 50. In a non-limiting illustrative example, the height of the gold “bowtie” can be 40 nm, and the thickness of the chemical material layer 50 can be about 0.5 nm. The first and second adhesion material portions (30A, 30B) can include chromium and have a thickness of about 8 nm, the first and second posts (12A, 12B) can include silicon and have a maximum lateral dimension of about 40 nm, and the height of the first and second posts (12A, 12B) can be about 200 nm.

The metallic nanostructures (30A, 40A, 30B, 40B) of the present disclosure are elevated above, and suspended over, a substrate 10, and are not directly attached to the substrate 10. The spacing between the metallic nanostructures (30A, 40A, 30B, 40B) and the substrate 10 is beneficial in that the spacing eliminates or reduces potential substrate perturbations or it can be used, for additional enhanced electromagnetic fields and/or plasmonic coupling.

The fabrication methods of the present disclosure allows for closing gap sizes of nanstructures, for example, down to 1 nanometer scale, which can be greater than 1 nm, or 1.5 nm, or 2 nm, or 5 nm, or 50 nm, and is less than 50 nm, or 10 nm, or 6 nm, or 4 nm. The smaller gap sizes lead to the higher electromagnetic field enhancement. Thus, the nanoarrays of the present disclosure have superior field enhancement factors with greatly improved sensitivity and reproducibility.

The elevated or suspended noble metallic nanostructures are useful for analytical techniques such as, but not limited to, surface enhanced Raman spectroscopy, electromagnetic field enhancement, and/or plasmonic device applications. For example, the elevated or suspended noble metallic nanostructures on a substrate can be used as a sensing material in a portable Raman sensor. In a further example, the elevated or suspended noble metallic nanostructures on a substrate can be used, for instance, in nano-scale light-emitting diodes (LED), electrically driven nano-scale light sources, photodiodes, phototransistors, and photomultipliers. Elevating a nanostructure having a nanoscale gap enhances the signal to noise ratio in surface enhanced Raman spectroscopy and other similar analytic setups compared to previously known structures that do not employs posts or elevation over a substrate.

### EXAMPLES

### Example 1

### Fabrication of Elevated Gold Bowtie Arrays on Silicon Wafers

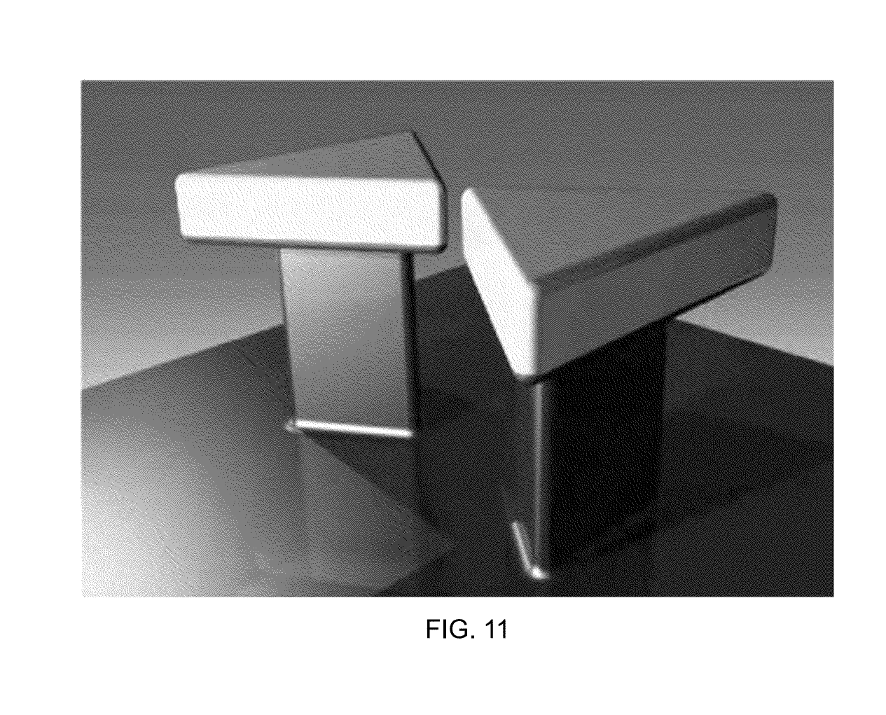

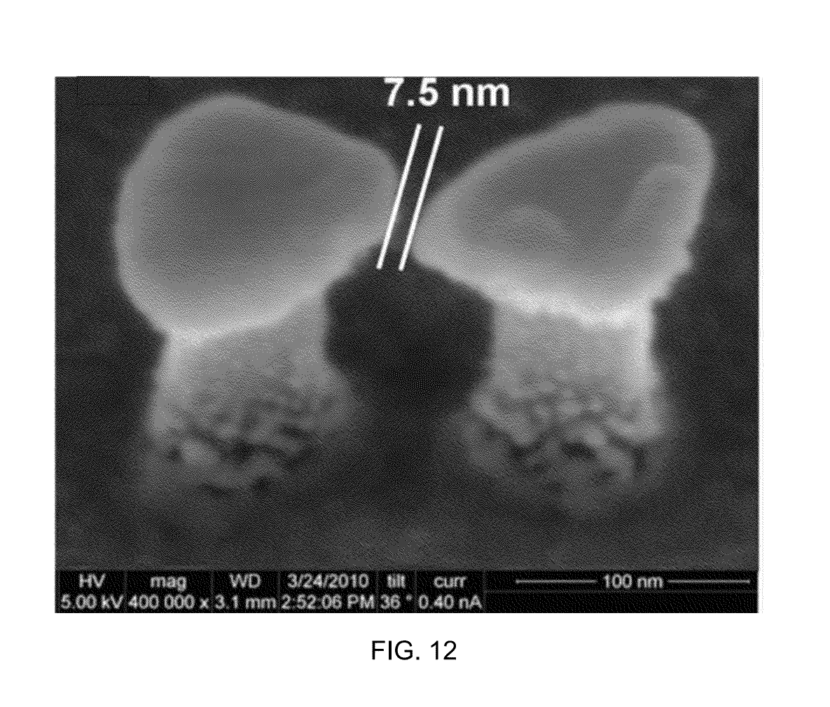

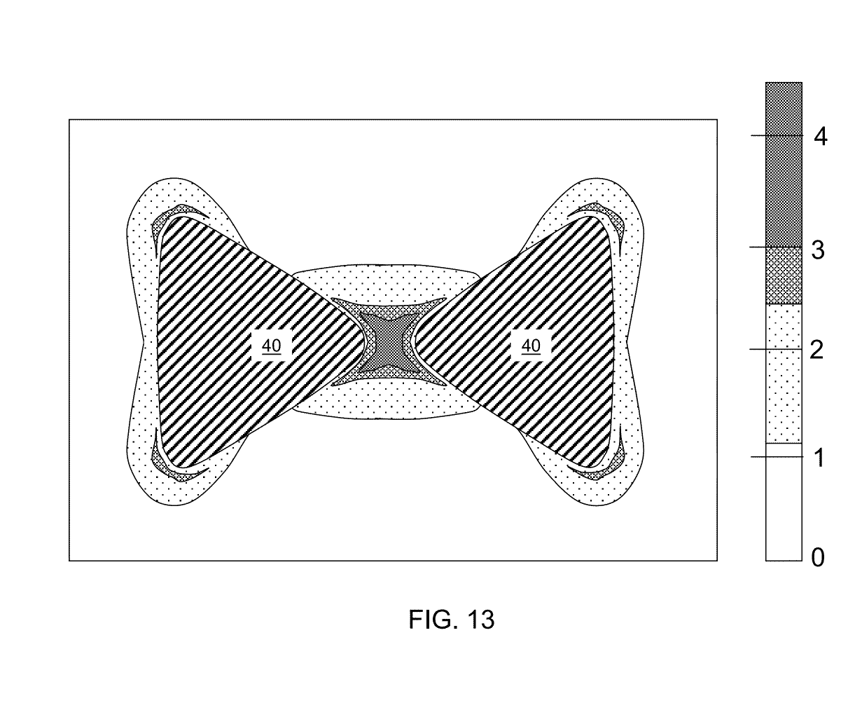

FIG. 11 shows a schematic illustration of these structures, together with a scanning electron microscope (SEM) image of the actual structures in FIG. 12, and the spatial distribution of the B field intensity calculated by finite difference time domain (FDTD) simulations shown in FIG. 13.

The bowtie arrays were patterned by electron beam lithography (EBL) on silicon wafers using a JEOL JBX-9300FS EBL system. A 300 nm-thick layer of ZEP52OA e-beam resist (ZEON Chemical L.P., Japan) was spun on a 4-in silicon wafer and baked at 180° C. for 2 minutes to harden the resist.

The resist was patterned at an acceleration voltage of 100 kV and exposed to a dose of 450 p.C/cm². After exposure, the resist was developed in xylene for 30 seconds, rinsed in isopropyl alcohol for another 30 seconds and dried under a stream of high-purity nitrogen.

Following development, the sample was exposed to an oxygen plasma for 6 s at 100 W (Technics Reactive Ion Etching System) to clean residual resist from the arrays. For the lift-off process, an 8-nm Cr layer was first deposited using an electron-beam dual gun evaporation chamber (Thermonics Laboratory, VE-240) equipped with a quartz crystal monitor to measure the thickness. The excess resist and Cr were removed by lift-off using an acetone bath followed by isopropyl alcohol rinse.

Following the lift-off process, the wafer was dried under a stream of nitrogen. An Oxford Reactive Ion Etching (RIE) system was used at a rate of about 100 nm/mm for 1.5 mm to etch the 200 nm tall silicon posts with the Cr metal pattern on the top to fabricate clean metallic bowtie arrays. The final step of Au deposition (40 nm in thickness) on top of the Cr layer was performed in the same electron-beam dual gun evaporation chamber.

Sample Characterization and Raman Spectroscopic Analysis.

Scanning electron microscope (SEM) imaging of elevated gold bowtie arrays was performed either with a JEOL JSM-7400F field emission SEM operated at 10 kV, or a FEI Nova 600 SEM focused ion beam system equipped with both a secondary electron detector and a backscattered electron detector.

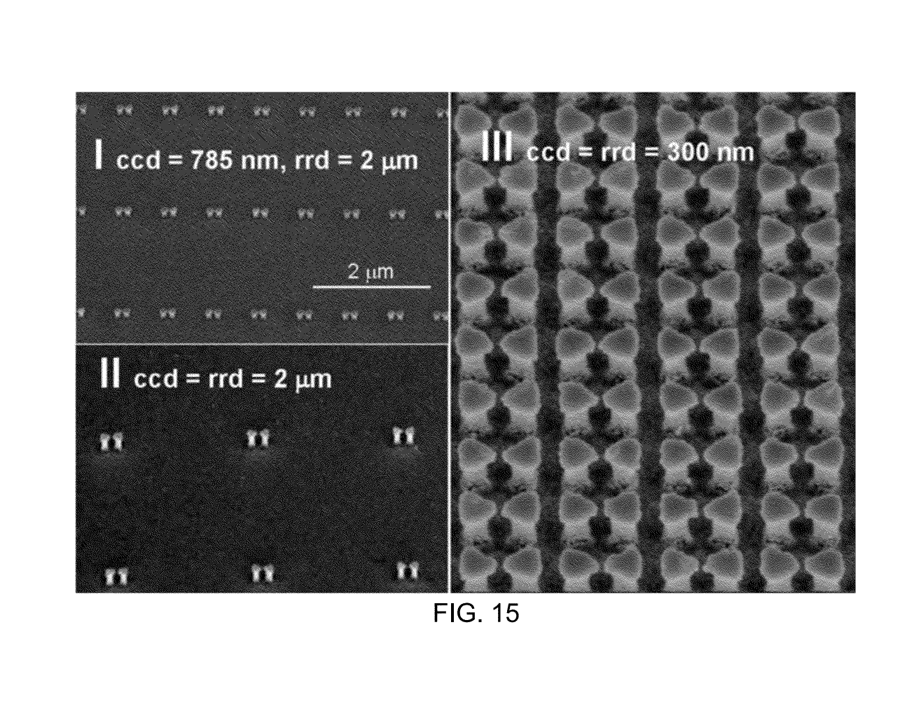

Bowties including triangles of 100 nm sides with 40 nm Au layer thickness on top of 200 nm tall Si posts were used for the gap-dependent SERS studies. The gap size (triangle tip-to-tip) varied from about 8 nm to 50 nm. Bowtie arrays with different spacing were produced by varying the column-to-column distance (ccd) or row-to-row distance (rrd). They include an isolated bowtie array with ccd=rrd=2 μm (II), a high-density array with ccd=rrd=300 nm (III), and a low density array (I) in FIG. 15 that matches the incident laser wavelength with rrd=2 μm and ccd=785 nm.

SEM images shown in FIGS. 12 and 15 were taken by secondary electron imaging with a high resolution. Lower resolution backscattered electron imaging was also used to distinguish between Au and Si to show that the Au layer is present on the bowties, and that the posts are not coated with Au. This is because the contrast in the backscattered electron images is a function of the atomic number (Z) of the elements.

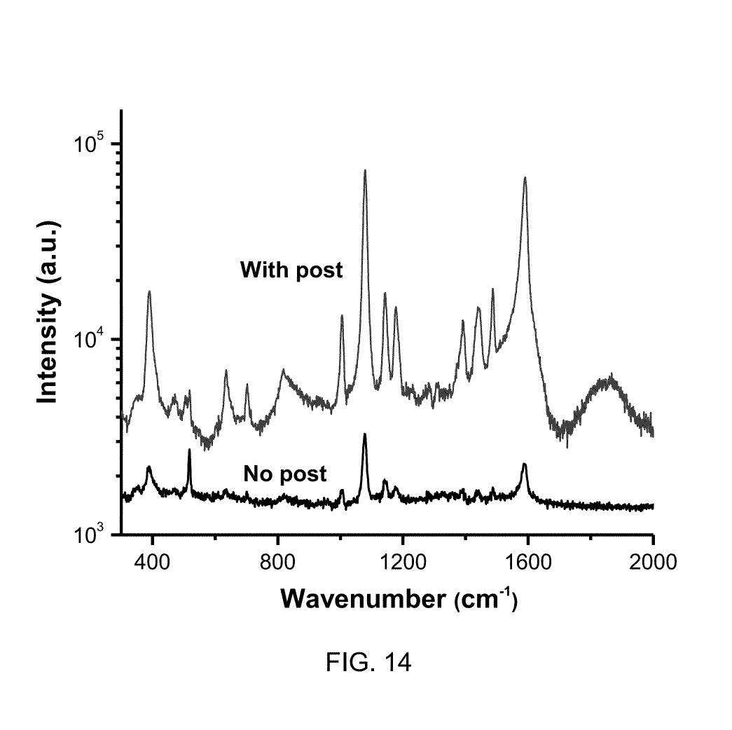

FIG. 14 is a graph that shows a comparison of SERS spectra of p-mercaptoaniline (pMA) from elevated bowtie array substrates (labeled “With post”) and nonelevated bowtie array substrates (labeled “No post”).

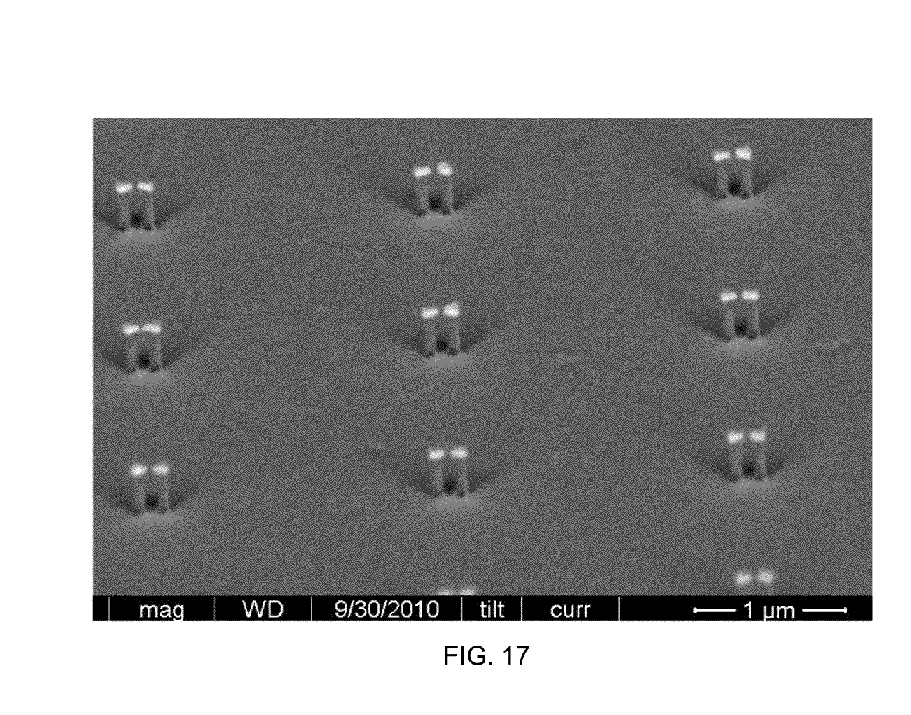

A typical backscattered electron image of bowtie arrays afterp-mercaptoaniline (pMA) sorption and rinsing with ethanol and water is shown in FIG. 17. The image shows two triangles facing each other with bright contrast corresponding to the Au layer (Z=79) covering the bowties, and gray posts on gray background corresponding to lower atomic number Si (Z14).

Without an adhesion material portions such as Cr, Au does not stick to silicon, or it is easily removed by subsequent cleaning and rinsing.

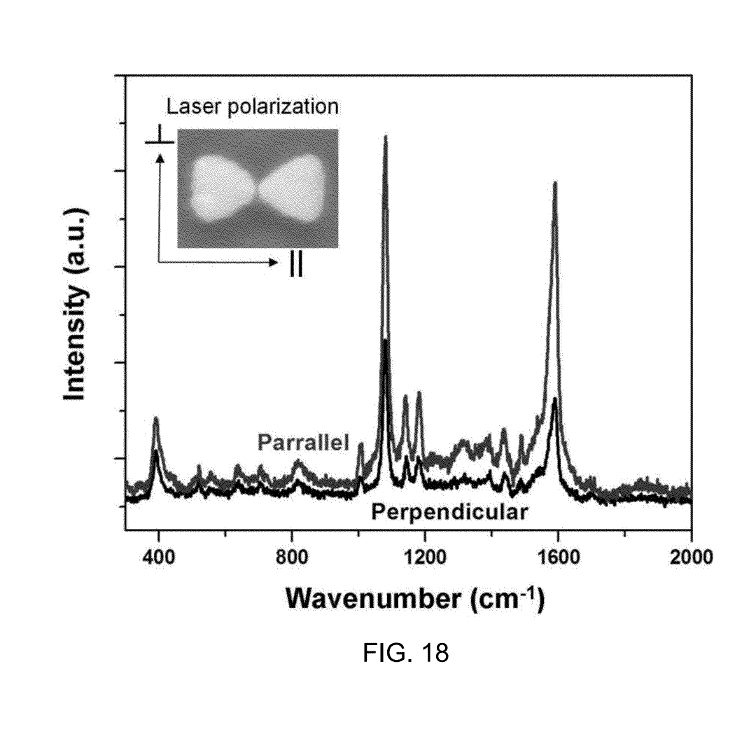

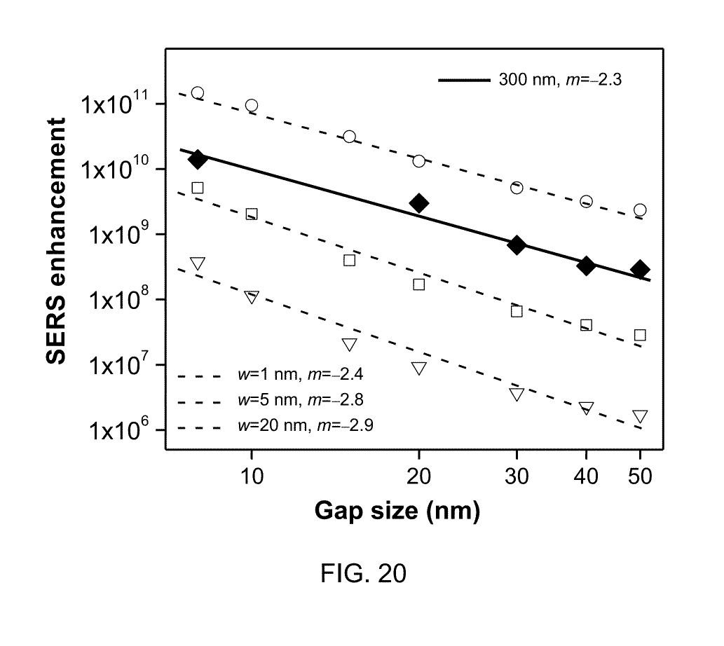

The SERS spectra were measured using a Renishaw micro-Raman system equipped with a 300-mW near-infrared diode laser at a wavelength of 785 nm (Renishaw mc, New Mills, UK). Typical SERS spectra at optical polarization of either parallel or perpendicular are shown in FIG. 18. The laser beam was set in position with a 50×, 0.5 NA (numerical aperture) Leica microscope objective at a spatial resolution of about 2 μm. For data shown in FIG. 15 and FIG. 20, the polarization was set parallel to the bowtie axis with an output power of about I mW at the exit of the objective.

The self-assembled monolayer of pMA was prepared by exposing the Au bowtie arrays to an aliquot of freshly prepared aqueous solution of pMA at 1.0×10⁻⁵ M (1.5 mL) in a plastic petridish for 12 hours at room temperature. Samples were then rinsed in a solution containing 10% ethanol and 90% deionized water (18.2 MΩ) to remove unbound pMA and dried with a flow of N₂. The maximum SERS signal was obtained by focusing the laser beam on the substrate, and the spectral data (N=8-13) were collected by moving the stage at ˜10 μm intervals (one spectral acquisition per step) over 1,600 μm² area. Spectral data were analyzed using the Galactic GRAMS software for each substrate pattern with different gap sizes and inter-bowtie distances.

A typical set of spectra collected from 13 different spots on a 1600 μm² bowtie array is shown in FIG. 18 with an estimated error of ±12% for the integrated band area at 1588 cm¹.

Determination of SERS Enhancement Factors.

The SERS enhancement factor (EF) was calculated based on Eq. (1) below:

$$EF = \frac{{I}_{SERS} {N}_{bulk}}{{I}_{bulk} {N}_{SERS}} , \qquad ( 1 )$$

where the SERS integrated band area at 1588 cm⁻¹ (I_{SERS}) is divided with that of the nonenhanced Raman signal of the same band (I_{bulk}). N_{bulk} and N_{SERS} are the number of molecules for the neat bulk sample (without SERS enhancement) and that excited by the localized field between the two triangles making up the bowties in the SERS measurement. An N_{bulk} of 3.1×10¹³ in the laser spot was estimated based on the focusing volume and a density of pMA of 1.06 g/cm³. N_{SERS} was calculated according to a previously established method where it was assumed that the E field enhancement that contributes to the SERS signal is at the tips of the triangles that form the bowtie gap. Since the two triangles have the same area of field enhancement and the pMA molecules uniformly cover the Au surfaces of the bowtie, the area is calculated as a cylinder with the Au film thickness of 40 nm being the height of the cylinder. The area of the cylinder includes two cylindrical halves with a radius of curvature of 15 nm representing the sides of the gold bowties as a conservative estimate from the SEM images, and two circles with the same radius representing the top (at the tip area) of the bowties. Accordingly, the estimated N_{SERS} is 1.1×10⁶ for ccd=rrd=300 nm, 2.2×10⁴ for ccd=rrd=2 μm, and 6.7×10⁴, for ccd=785 nm and rrd=2 μm bowtie arrays based on a packing density of 0.20 nm²/molecule of pMA.

Computational Algorithm and Model Simulations

Lumerical finite difference time domain (FDTD) Solutions software was used to simulate the electromagnetic field intensity. A graphical representation of the E field intensity versus location in the plane of a periodic array of elevated gold bowtie structures (FIG. 10A) was used to calculate the location of the maximum enhancement. Because a perfectly sharp tip at the apex of the triangular prism cannot be achieved experimentally, simulations of finite sharpness bowtie structures have been performed following previously established methods by either truncating the tips of the triangle or assuming a curvature at the apex. A simple geometry of the bowtie structure with truncated apexes is considered in the present study to elucidate the essential trends of how the near-field plasmon resonance varies with the gap size, d, and the truncation width, w. The Si post has a smaller x-y cross-section than the bowtie structure with edges also truncated. For simplicity, the Si post is assumed to be a cylinder in the simulations, and the central line of the cylindrical post is assumed to align with the centroid of the triangle with a size of 100 nm and a gold thickness of 40 nm. The diameter of the Si post is 40 nm, and a sorbed layer of the pMA analyte of 0.5 nm on the exposed gold surfaces is also assumed. The x-y dimensions of the unit cell adopted in simulations correspond to experimentally used ccd and rrd values. The dielectric properties of Au, Cr, and Si were taken from Palik's handbook, and the dielectric constant of pMA is 7. A plane wave (at 500 to 1000 nm wavelength) polarized across the junctions between triangles (i.e., along the x-direction) is illuminated in the negative z-direction of the bowtie. Because the laser illumination is polarized along the x-direction and the bowtie structure is periodic, anti-symmetric boundary condition is used at x=0 and the upper boundary of x in the unit cell, whereas symmetric boundary condition is used at y=0 and the upper boundary of y. Using these symmetric and anti-symmetric boundary conditions, only a quarter of the unit cell is required in simulations. Various simulation domains in the z-direction have been adopted to ensure the convergence of the simulation results, and the top and the bottom of the simulation domain are defined, respectively, at 360 nm above the Au bowtie and 100 nm below the Si post so that the total z-dimension of the simulation domain is 700 nm. The perfectly matched layers are used at the top and the bottom of the simulation domain to completely absorb waves leaving the simulation domain in the wave propagation direction. The mesh sizes in the bowtie region (including analyte, gap, and Cr layer) vary from 0.25 to 1 nm, and automatic graded mesh with a mesh accuracy of 4 is used in the region outside the bowtie.

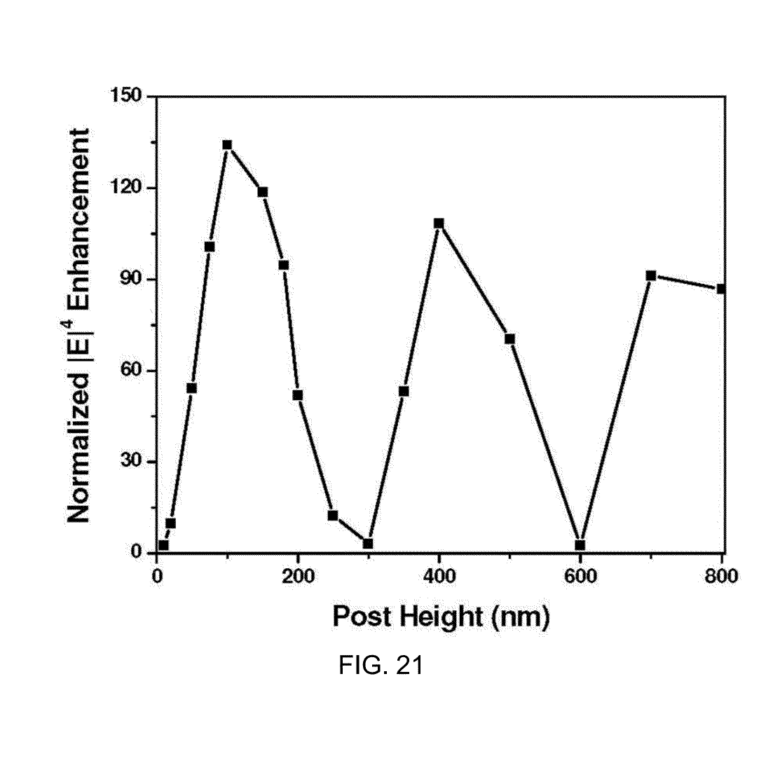

The simulation results of the maximum electric field enhancement |E|⁴ as a function of the post height are shown in FIG. 21. The plot of |E|⁴ normalized by that for bowties directly attached on Si substrate (no posts) shows periodic crests (at ˜100, ˜400, and ˜700 nm) and valleys (at ˜300 and ˜600 nm) with a period of ˜300 nm. This behavior is similar to the resonance in a cavity, which has the standing wave resonance for every half wavelength along the cavity length. Based on the periodicity of ˜300 nm, the guiding wavelength in the cavity should be ˜600 nm. However, it should be noted that unless it is an idealized cavity, this guiding wavelength is not necessarily the same as the incident wavelength.

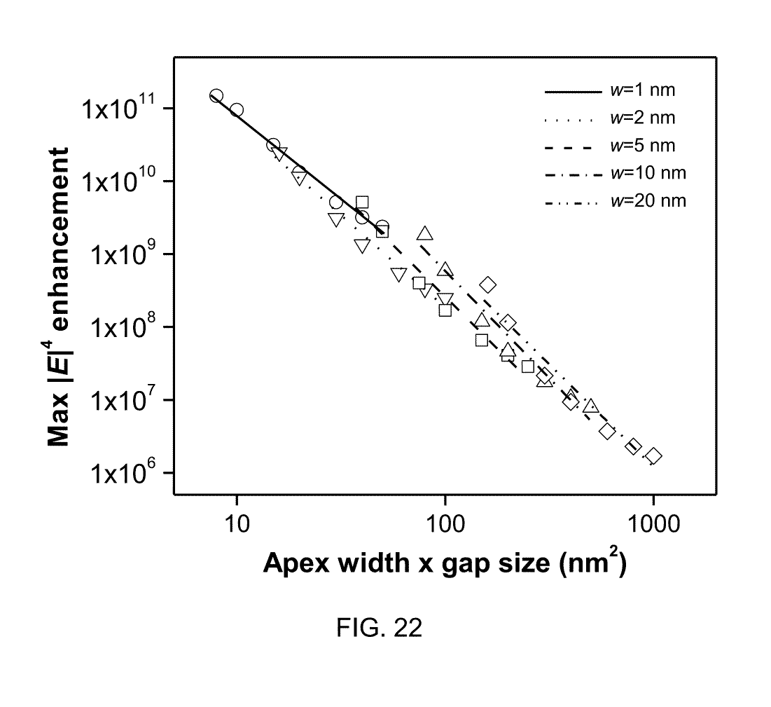

FDTD simulations of the maximum |E|⁴ enhancement as a function of the gap size, d, are also performed at varying apex widths for ccd=rrd=300 nm (FIG. 20). For d>50 nm, the FDTD results show that the |E|⁴ enhancement is insensitive to the gap size because the two triangular prisms are sufficiently far apart to eliminate near-field coupling. However, for d<50 nm, the maximum |E|⁴ enhancement versus d can be fitted by a power law: |E|⁴ Ad^{m} where A and m are fitting parameters with A the intercept of the line and m the slope in the log-log plot. It is of interest to explore the meaning of the power-law dependence. The E field intensity in a plasmonic nanocavity is a function of the cavity geometry and quality factor. A general equation to describe this field intensity for all plasmonic cavity structures is unattainable, and a semiquantitative approach is thus used in the present study to describe the bowtie nanocavity effect. For a bowtie nanocavity, the field intensity is inversely proportional to the effective volume. For a small gap size, the field is highly confined in the gap region and the radiation loss is neglected for simplicity in analyses because the field is highly confined at the resonant frequency. While the effective volume of the bowtie cavity is proportional to the product of the apex width, w, the gap size, d, and the height of the bowtie, the E field intensity is approximately inversely proportional to the product of w and d when the height is fixed. Hence, for a fixed bowtie height, the |E|⁴ enhancement is proportional to (wd)⁻². FIG. 22 shows the maximum |E|⁴ enhancement versus wd in a log-log plot. The results show that the slope falls within a narrow range at about −2.5 that qualitatively agrees with the predicted value of −2 and also the experimentally determined value of about −2.2.

### Example 2

### SERS Enhancement Factors Exceeding 10¹¹ Resulting from Elevated Gold Bowtie Nanoanatenna Arrays with Array Periodicity

A process combining nanofabrication steps of pattern definition by EBL, metal deposition, lift-off, and reactive ion etching (RIE) arranged in a particular sequence was used to fabricate the elevated gold bowtie arrays on Si wafers according to details given in Example 1 above.

Briefly, a precisely controlled deposition of 40 nm gold on a Cr adhesion material portions located on top of 200 nm tall Si posts was used to close the 20 nm gap size defined by EBL to 8±1 nm. This step also produces the characteristic overhang that along with the post defines the three-dimensional nanoantenna and distinguishes these structures from gold bowties that remain attached to the substrate.

The contrast in SEM backscattered electron images (FIG. 17) shows that only the bowties and not the posts are coated with gold. A comparison of SERS spectra of elevated bowties with that of bowties attached to the substrate is shown in FIG. 14. The elevated bowties allow manifestation of intrinsic plasmonic coupling effects in suspended nanocavities, or the tip-to-tip nanogaps, from structures that are not in physical contact with a substrate. This configuration results in up to 2 orders of magnitude additional enhancement in SERS response compared to that of nonelevated bowtie arrays. The influence of the post heights on the SERS response is confirmed by and qualitatively agrees with FDTD simulation results illustrated in FIG. 21.

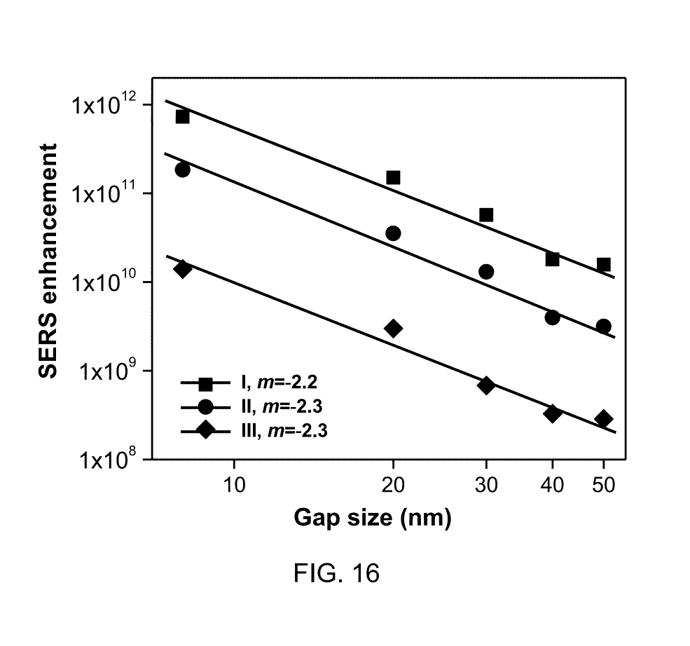

Different density arrays shown in FIG. 15 were fabricated by changing the center-to-center distance (ccd) in rows along the bowtie axis, and the row-to-row distance (rrd). The isolated bowtie arrays shown in image II of FIG. 15 have a dimension of ccd=rrd=2 μm that is close to the laser spot size, which ensures that the SERS measurements represent local response from a single bowtie. Next, the SERS response of isolated bowties were compared with that from high-density (III) and low-density (I) arrays in FIG. 15 with specific periodicity of ccd=rrd=300 nm, and ccd=785 nm, rrd=2 μm, respectively. The Raman EF for these arrays shown in FIG. 16 was determined from the SERS intensity of a probing molecule, p-mercaptoaniline (pMA).

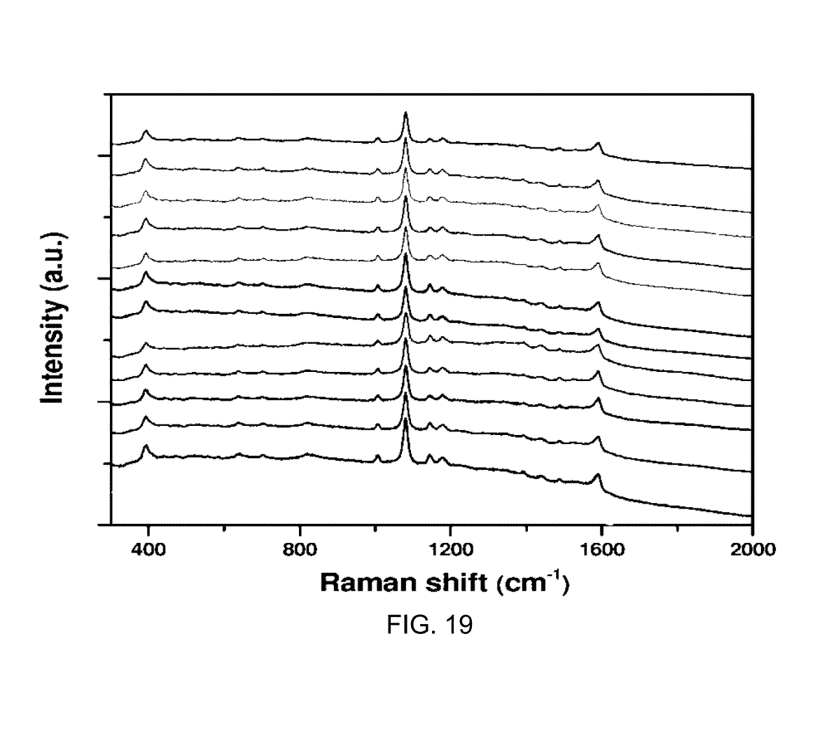

Exposure of the bowties to a pMA solution (10⁻⁵ M) results in the chemisorption and uniform coating of the gold surface by a monolayer of pMA molecules that ensures unambiguous determination of the SERS enhancement and good reproducibility (FIG. 19). The EF was determined following a procedure described in Example 1 above. Here the EF represents the ratio of the SERS signal to the nonenhanced bulk Raman signal measured and normalized per molecule for the 1588 cm⁻¹ Raman band.

For all arrays, the EF increases with decreasing gap size and reaches 2×10¹¹ and 7×10¹¹ at the smallest gap of 8±1 nm for the isolated and low-density bowtie arrays (FIG. 16). These values match the largest enhancements reported for nanoshells and nanoparticle aggregates that typically contain a number of randomly distributed hot spots. In addition to the distinct gap size dependence that dominates the response of isolated bowties, we demonstrate that the bowtie arrays are also subject to collective interactions (far field effect) that either degrade or further enhance the overall SERS response. The trends in FIG. 16 identify the array periodicity as the critical factor that determines the EF change. The maximal enhancement is achieved when the periodicity of the arrays matches the laser wavelength. In particular, the EF from the high-density bowtie array with ccd=rrd=300 nm (III in FIG. 15) was about 1 order of magnitude lower than that for the isolated bowties. In contrast, the low-density arrays with optimized periodicity of ccd=785 nm (I in FIG. 15) that matches the Raman laser wavelength, produced an EF with nearly an order of magnitude additional increase above that for isolated bowties. These observations represent the first definitive experimental confirmation of the theoretically predicted long-range collective photonic effect.

The FDTD simulations identify the shape and sharpness (w) of the triangle's apex (FIG. 10A) as factors that affect efficient coupling of the incident optical radiation into the bowtie gap. The spatial distribution plot of the E field intensity in FIG. 13 shows that for elevated bowties the nanogap effect is strongly localized in the volume between the tips of the triangles. In addition, FIG. 20 illustrates that the nanogap effect and the resulting SERS response become stronger with the apex sharpness (w) increasing from 20 to 1 nm.

The elevated gold bowtie arrays reveal another important feature of the EF. A log-log plot of the EF against the gap size, d, gives a straight line with a slope (m) near −2.2±0.1 for the bowtie arrays (See FIG. 16). Similar magnitude and slope are obtained using FDTD simulations for the high-density bowtie arrays with apex width near 1 nm (FIG. 20). On the basis of the general relationship of the EF |E|⁴=AD^{m} this behavior is equivalent to a weak power law dependence of E on the gap size given by E˜d^{-0.56} that is even weaker than the decay of a monopole field according to Coulomb's law of E˜d⁻² These findings suggest that narrowing the gap separation between the two prisms below ˜50 nm the bowties enter into a regime characterized by exceptionally strong E field within the gap region. In this strongly coupled regime, the E field shows little attenuation possibly due to resonant nanocavity effects supported by both experimental observations and the FDTD simulation (See FIG. 22). However, the weak power law dependence may also include a component resulting from red shifting of the plasmon resonant frequency with decreasing gap size. According to the plasmon ruler equation the plasmon wavelength shift reaches maximum for very small gap sizes and decays exponentially with the gap size. Nevertheless, an important technological significance of this weak attenuation comes with the realization that in the strong coupling regime the arrays can tolerate a certain degree of gap size nonuniformity and geometrical imperfection without losing their ability for large field enhancement. The spatial localization of a free-standing, finite plasmonic volume enabled by the three-dimensional suspended bowtie nanoantenna substantially expands the versatility of utilizing E-field enhancement that has numerous applications in chemistry and physics including single molecule spectroscopy, and a variety of advanced optical characterization, manipulation, and optical information processing using periodic metallic nano structures.

### Example 3

### Portable Raman Sensor Integrated with Gold Bowtie SERS Arrays for the Detection and Monitoring of Environmental Pollutants

Substrate Preparation and Characterization

Gold bowtie nanostructural array substrates were fabricated by electron beam lithography (EBL) using a JEOL JBX-9300FS EBL system (JEOL, Japan). In brief, a 300-nm thick layer of ZEP52OA e-beam resist (ZEON Chemical, Japan) was spun on a 4-in silicon wafer that was subsequently baked at 180° C. for 2 minutes to harden the resist. The resist was then patterned at an acceleration voltage of 100 kV and exposed to a dose of 450 μC/cm². After exposure, the resist was developed in xylene for 30 s, rinsed in isopropyl alcohol for another 30 s and then dried under a stream of nitrogen. Following the development, the sample was exposed to oxygen plasma for 6 s at 100 W (Technics Reactive Ion Etching System) to remove residual resists on the arrays. For the lift-off process, an 8-nm Cr layer was first deposited using an electron-beam dual gun evaporation chamber (VE240, Thermonics Laboratory, Port Townshend, Wash.) equipped with a quartz crystal monitor to measure the thickness; the excess resist and Cr were removed via lift-off using an acetone bath followed by an isopropyl alcohol rinse. Following the lift-off process, the wafer was dried under a stream of nitrogen. An Oxford Reactive Ion Etching (RIE) instrument (Oxfordshire, UK) was subsequently used at a rate of 100 nm/mm for 1.5 minutes to create the silicon post with the Cr metal pattern on the top and to generate elevated bowtie arrays.

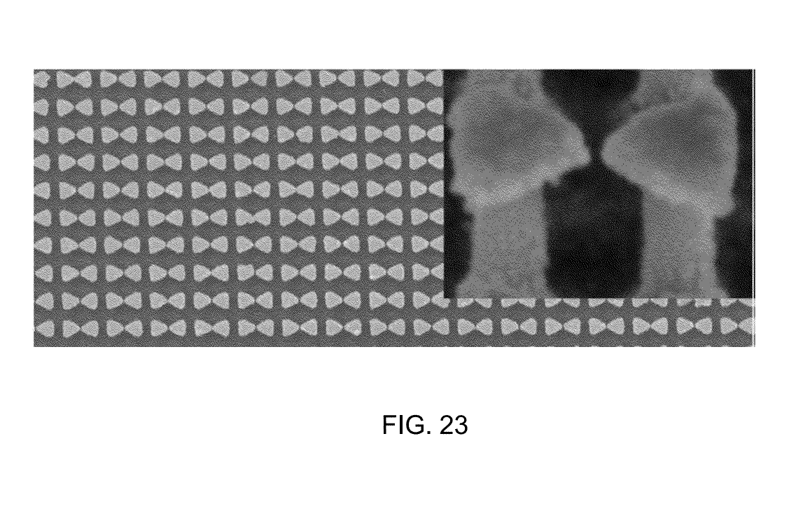

A 40-nm thick gold film was subsequently deposited using the same evaporation chamber to generate the SERS active substrate. All bowtie arrays were made with pairs of triangular prisms (100-nm in size) with a tip-to-tip gap distance of about 8 nm and a center-to-center distance of 300 nm, respectively (FIG. 23). The array size is 1×1 mm, and each wafer (4-in diameter) contains 24 identical arrays for sample analysis. Scanning electron micrographs (SEM) of these arrays were obtained either with a JEOL JSM-7400F (JEOL, Tokyo, Japan) or a FEI Nova 600 scanning electron microscope (FBI Oregon, USA) with a field emission gun operated at 10 kV.

All SERS spectra were collected with a portable EZRaman-M system equipped with an InPhotonics fiber optic Raman probe and a miniaturized camera stage attached to it. A diode laser operating at 785 nm is used as the excitation source with a high Rayleigh rejection fiber optic probe, which serves three purposes: (1) transmission of the incident laser to the sample, (2) collection of the scattered Raman signal to the spectrograph, and (3) removal of unwanted background signals through an optical filtering device. For sample analysis, the Au bowtie array substrates were mounted on the xyz stage to allow precise focusing and mapping of the entire surface. The incident laser is then focused onto the array substrates and the scattered SERS signals are collected by the spectrograph detector system. Each spectrum was accumulated over a period of 60 s and analyzed by ThermoGalactic GRAMS software.

Analyte Samples and Data Acquisition

Sodium Perchlorate (NaClO₄.H₂O) was purchased from EM Science (Cherry Hill, N.J.). Trinitrotoluene (TNT) reference standard (1 mg/ml in MeOH:ACCN 1:1) was purchased from AccuStandard, Inc. (New Haven, Conn.). De-ionized (DI) water with resistivity greater than 18.2 mΩ·cm (Barnstead B-pure) was used throughout the experiment. Standard solutions of perchlorate in the concentration range of 10⁻³ M to 5×10⁶ were prepared from a stock solution of 1×10²M. The calibration curves and reproducibility studies were performed in the same day and from the same wafer to reduce errors associated with instrument variation. A small droplet of standards or samples (˜20 μl) were placed on the array substrate and subsequently analyzed after air drying.

To evaluate the applicability of the SERS probe for environmental analysis, contaminated groundwater samples were obtained from several selected US Department of Defense's facilities and were used as received. The general characteristics and ionic compositions of these samples are shown in Table 1. To avoid potential matrix interferences due to unknown background organic or inorganic ions in the groundwater, the standard addition method was used, to which varying amounts of the perchlorate or TNT standard solution were added to a fixed amount of the groundwater. The final volumes were made up to 25 mL using DI water. The sample was then analyzed, and the characteristic Raman intensities at 947 cm⁻¹ for perchlorate and 1367 cm⁻¹ for TNT were plotted against the final concentration of perchlorate or TNT. A linear regression was used to calculate the absolute value of the x-intercept, which corresponds to the true concentrations of perchlorate or TNT in the groundwater.

TABLE 1
General geochemical pronerties of groundwater samples

| Sample | Chloride | Sulfate | Nitrate | Phosphate | TOC | |
|---|---|---|---|---|---|---|
| Name | (mg/I) | (mg/I) | (mg/L) | (mg/I) | (mg/I) | pH |
| Site I | | | | | | |
| GWOBODO | 8.4 | 9.5 | 1.2 | <0.1 | 5 | 5.2 |
| 2 | | | | | | |
| GWOBODO | 6.7 | 6.4 | 0.9 | <0.1 | 3.4 | 5.45 |
| 3 | | | | | | |
| Site 2 | | | | | | |
| MW-01 | 77.4 | 1.7 | <0.1 | <0.1 | 20.3 | 5.91 |
| MW-04 | 193.0 | 13.5 | 1.6 | <0.1 | 12.6 | 6.32 |
| Site 3 | | | | | | |
| TNTMW38 | 23.8 | 94.8 | 8.8 | <0.1 | 4.8 | 7.39 |

Portable Raman Sensor for Detecting Energetic Compounds

Perchlorate is a widespread contaminant found in groundwater and surface water and is a key component of solid rocket fuel, explosives, fireworks, road flares and other products. Perchlorate can also form naturally and is believed to affect the human thyroid function by inhibiting iodide intake. TNT is another common contaminant from explosives found in soil and groundwater and is a toxin to humans and aquatic organisms. Standard methods to detect perchlorate and TNT, are ion chromatography (IC) and high-performance liquid chromatography (HPLC), which requires extensive sample preparation and analytical time. Thus, a portable Raman sensor that is integrated with lithographically fabricated bowtie SERS substrates for the detection and monitoring of energetics such as perchlorate and TNT in the environment was developed.

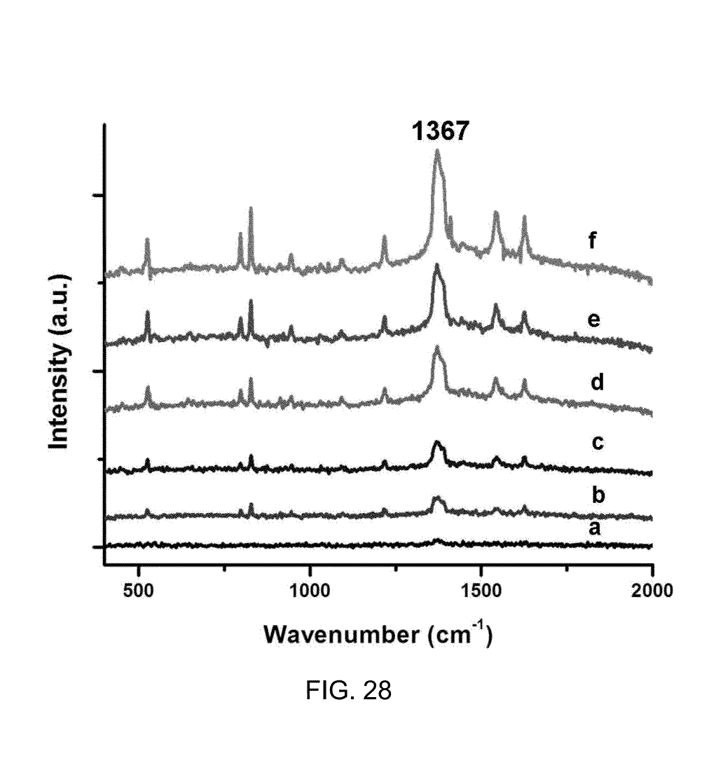

The elevated gold bowtie arrays were fabricated as described above, and used as sensitive SERS substrates for detecting energetics by the portable Raman sensor. FIG. 23 shows a typical scanning electron microscope (SEM) image of the actual structures, in which the characteristic overhang gold bowties are located on top of 200-nm tall silicon posts. A precisely controlled deposition of 40 nm gold was used to close the tip-to-tip gap size of the bowtie to 8±1 nm. Aside from improved reproducibility (due to the structural uniformity), one of the advantages of using such elevated structures is to make them fully decoupled from substrate interactions. This improves the quality factor and the plasmonic coupling efficiency in the structures, leading to large SERS enhancement factors as demonstrated in Example 2 above. The enhancement was also found to increase with decreasing the gap size with the highest enhancement observed at the gap size of ˜8 nm (the smallest gap fabricated by EBL). These structures are therefore used in this study for detecting perchlorate and TNT in both laboratory simulated and groundwater samples. SERS spectra were collected with a portable EZ Raman M system (described above, see also FIG. 28).

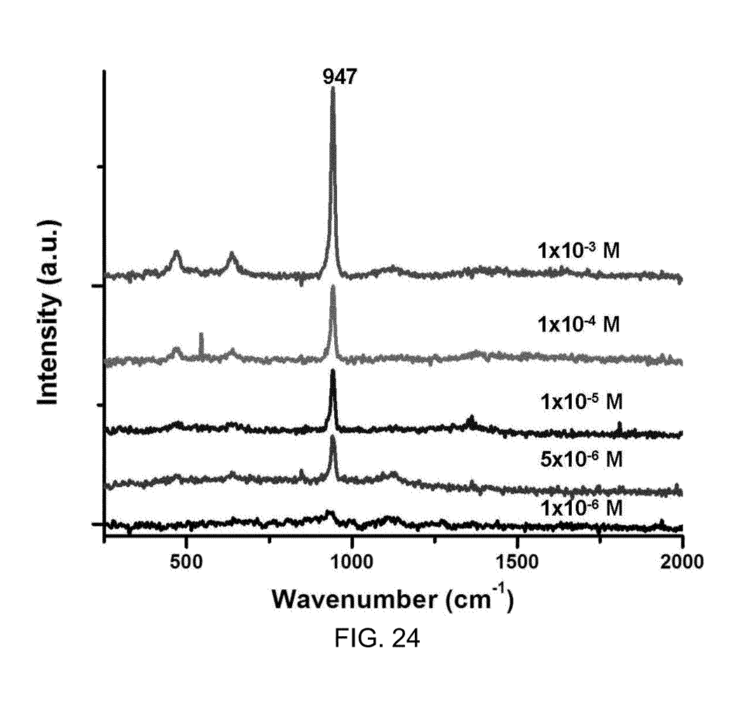

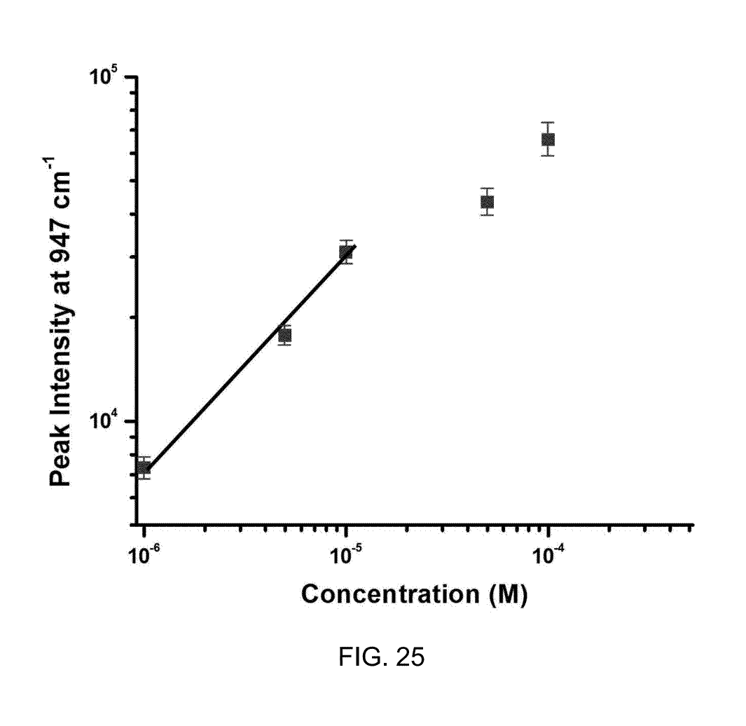

A series of tests of the portable Raman system was performed by collecting SERS spectra of standard perchlorate solutions at concentrations ranging from 10⁻³ M to 10⁻⁶ M in water. FIGS. 24 and 25 show the spectra of perchlorate, which are offset for clarity of the presentation. The strongest SERS peak occurred at about 947 cm⁻¹ as a result of symmetric stretching vibration of perchlorate molecule and is in close agreement with that previously reported in the literature. The lowest perchlorate concentration detected was about 10⁻⁶ M with a notable SERS peak. This detection is equivalent to an enhancement factor of 10⁴ to 10⁵ by SERS due to enhanced electromagnetic fields generated at or near the surface of elevated gold bowtie arrays. The detection limit is better or comparable with some of the previous studies but it is about two orders of magnitude higher than those reported recently using surface modified gold nanoparticles. This study represents the first reported case of perchlorate being detected using a portable Raman spectrometer on elevated Au bowtie array substrates.

A log-log plot of the peak intensity of the primary Raman scattering band at 947 cm⁻¹ indicate that, at relatively low perchlorate concentrations (1×10⁻⁶M-1×10⁻⁵ M), the peak intensity increased linearly with the perchlorate concentration (R²=0.998), but it leveled off at higher concentrations (5×10⁻⁵M-1×10⁻⁴ M)(FIG. 25). This nonlinear relationship between peak intensity and perchlorate concentration is in fact common by using vibrational spectroscopic techniques such as SERS. The observation is partially attributed to limited sorption sites within the gap region of the bowtie arrays and also a wide perchlorate concentration range used in the study. Nonetheless these results suggest that the technique could potentially be used for quantitative or semi-quantitative analysis of perchlorate within a given concentration range.

Reproducible substrates are important for SERS to become an invaluable tool for quantitative analysis. The SERS spectra collected from five different 1-mm² substrate arrays or from five different spots within a given substrate array in order to evaluate the reproducibility of the new bowtie substrates and the portable Raman system. Results indicate that, at a given perchlorate concentration (10⁻⁵M), the substrate-to-substrate variation for the peak intensity at 947 cm⁻¹ is found to be about 18%, whereas the spot-to-spot reproducibility is about 10% across five randomly selected spots. These observations are attributed to the fact that EBL is capable of fabricating highly uniform or evenly distributed nanogaps with spatial resolution of nanometers serving as “hot spots” for perchlorate detection. Therefore, the use of elevated gold bowtie arrays as SERS substrates shows clear advantages with respect to sensitivity and reproducibility for SERS applications.

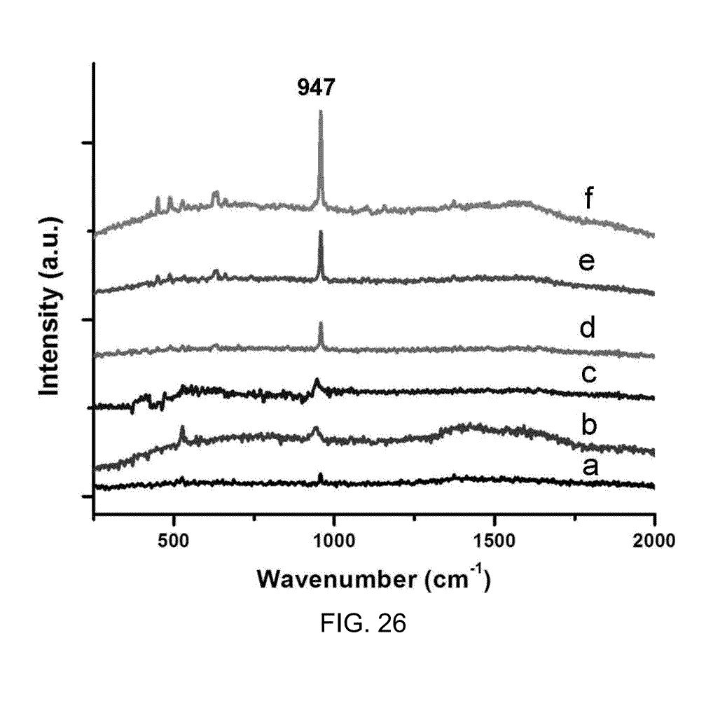

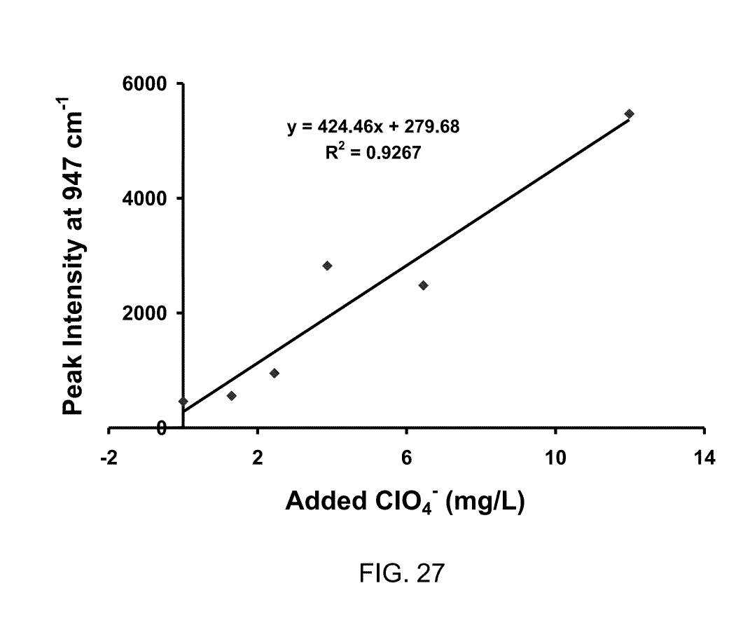

To evaluate the applicability of our portable Raman system for potential field applications, a number of realistic contaminated groundwater samples (Table 1) were collected and analyzed. Like any other techniques, analysis of realistic environmental samples by SERS presents a unique challenge because samples often contain multiple contaminants with unknown matrix compositions, which may interfere with the analysis and result in false positive responses. This is further complicated by the fact that concentrations of the analyte of interest (perchlorate and TNT in this case) are usually orders of magnitude lower than organic and inorganic interfering ions such as total organic carbon, chloride and sulfate (Table 1). As a result, the standard addition technique to correct for matrix interferences were adopted. Results are shown in FIGS. 12 and 13 as examples, and all additional data are summarized in Table 2 along with the concentration data determined by standard EPA Methods 314 for perchlorate and 8330 for TNT for comparisons. For groundwater sample (ID: GWOBODO2), the major contaminant is perchlorate. Results reveal that the peak intensity for perchlorate at 947 cm⁻¹ increased consistently with increasing concentration of the added perchlorate in solution (FIGS. 26 and 27). The measured concentration by SERS was 0.66±0.20 mg/L (˜6.6 μM), compared favorably with that determined by IC via EPA Method 314. The errors reported in the perchlorate concentration data represent the standard deviation determined using the method by Skoog et al. (Analytical Chemistry An Introduction. 7th ed.; Harcourt College: Orlando, Fla., 2000; p 601). For all groundwater samples, data analyzed by SERS are in general agreement with those analyzed by IC, again indicating that the portable Raman system can potentially be used for rapid, in-situ analysis of environmental samples.

TABLE 2
Analysis of groundwater samples by the portable Raman
sensor and comparisons of the analytical results with those
determined by EPA Methods 314 and 8330 for
ClO⁴ and TNT respectively.

| | Perchlorate (mg/L} | | TNT (mg/L) | |
|---|---|---|---|---|
| Sample | HPLC | SERS | HPLC | SERS |
| GWOBODO2 | 0.26 | 0.85 ± 0.71 | ND | ND |
| GWOBODO3 | 0.59 | 0.66 ± 0.20 | ND | ND |
| MW-O1 | 18.40 | 11.50 ± 15.4 | ND | ND |
| MW-04 | 14.70 | 6.15 ± 15.5 | ND | ND |
| TNTMW38 | ND | ND | 0.26 | 0.20 ± 0.11 |

a. “ND”: not detected

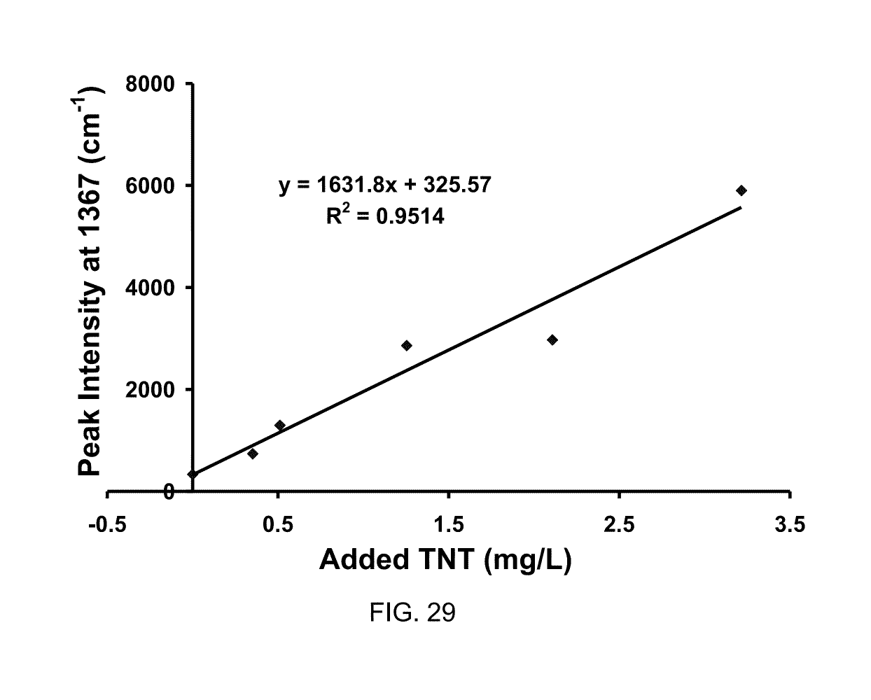

An additional advantage of using SERS is its versatility for detecting different contaminants or compounds either individually or simultaneously based on their characteristic vibrational frequencies of the molecules. It was demonstrated by the use of the portable Raman sensor for detecting TNT in the contaminated groundwater. The groundwater (ID: MW38) is contaminated with TNT at about 0.26 mg/L (analyzed by HPLC) but non-detectable amounts of perchlorate (Table 2). Similarly, using the standard addition technique, it was observed that the TNT peak intensity at 1367 cm⁻¹ increased consistently with increasing concentration of TNT in solution (FIGS. 28 and 29). The measured concentration by SERS is 0.20±0.11 mg/L (˜0.9 μM), agreeing reasonably well with that determined by HPLC (Table 2). This detection limit is comparable to that reported for the detection of TNT (10⁻⁷ M) using silver and gold nanoparticles in laboratory prepared solutions.

While the disclosure has been described in terms of specific embodiments, it is evident in view of the foregoing description that numerous alternatives, modifications and variations will be apparent to those skilled in the art. Each of the embodiments described herein can be implemented individually or in combination with any other embodiment unless expressly stated otherwise or clearly incompatible. Other suitable modifications and adaptations of a variety of conditions and parameters normally encountered in image processing, obvious to those skilled in the art, are within the scope of this disclosure. All publications, patents, and patent applications cited herein are incorporated by reference in their entirety for all purposes to the same extent as if each individual publication, patent, or patent application were specifically and individually indicated to be so incorporated by reference. Accordingly, the disclosure is intended to encompass all such alternatives, modifications and variations which fall within the scope and spirit of the disclosure and the following claims.

What is claimed is:

1. A structure comprising at least one unit structure located on a substrate, each of said at least one unit structure comprising:
a first metallic pad having a first pointed tip, a first planar top surface, and a first planar bottom surface;
a second metallic pad having a second pointed tip, a second planar top surface, and a second planar bottom surface, wherein said first pointed tip and said second pointed tip point at each other and spaced from each other by a dimension less than a maximum lateral dimension of said first and second metallic pads, wherein said substrate is vertically spaced from said first and second planar bottom surface;
a first post located on, and above, said substrate and below said first metallic pad and providing mechanical support to said first metallic pad; and
a second post located on, and above, said substrate and below said second metallic pad and providing mechanical support to said second metallic pad.

2. The structure of claim 1, wherein said first metallic pad and said second metallic pad comprises a noble metal.

3. The structure of claim 1, wherein said first metallic pad has a first generally triangular horizontal cross-sectional shape, said first pointed tip is located at an apex of said first generally triangular horizontal cross-sectional shape, said second metallic pad has a second generally triangular horizontal cross-sectional shape, and said second pointed tip is located at an apex of said second generally triangular horizontal cross-sectional shape.

4. The structure of claim 1, wherein said first metallic pad has a first generally elliptical horizontal cross-sectional shape, said first pointed tip is located at a vertex on a major axis of said first generally elliptical horizontal cross-sectional shape, said second metallic pad has a second generally elliptical horizontal cross-sectional shape, and said second pointed tip is located at a vertex on a major axis of said second generally elliptical horizontal cross-sectional shape.

5. The structure of claim 1, wherein each of said at least one unit structure further comprises;
a first adhesion material portion contacting a bottom surface of said first metallic pad and contacting a top surface of said first post; and
a second adhesion material portion contacting a bottom surface of said second metallic pad and contacting a top surface of said second post.

6. The structure of claim 5, wherein peripheral portions of said first adhesion material portion extend farther outward than sidewalls of said first post, and peripheral portions of said second adhesion material portion extend farther outward than sidewalls of said second post.

7. The structure of claim 5, wherein sidewalls of said first post are laterally recessed from sidewalls of said first adhesion material portion by a first lateral offset distance, and sidewalls of said second post are laterally recessed from sidewalls of said second adhesion material portion by a second lateral offset distance.

8. The structure of claim 7, wherein said first lateral offset distance and said second lateral offset distance are the same as measured at a same horizontal plane that intersects said first and second posts.

9. The structure of claim 1, wherein each of said first metallic pad and said second metallic pad has a substantially same horizontal cross-sectional area between a topmost surface thereof and a bottommost surface thereof.

10. The structure of claim 1, wherein said at least one unit structure is a plurality of unit structures arranged as a two-dimensional array on said substrate, wherein said two-dimensional array is a periodic array having a first pitch along a first horizontal direction and having a second pitch along a second horizontal direction that is perpendicular to said first horizontal direction.

11. A method of forming a structure comprising:
forming a first adhesion material portion and a second adhesion material portion on a top surface of a substrate, wherein said first adhesion material portion has a first pointed tip and said second adhesion material portion has a second pointed tip, wherein said first pointed tip and said second pointed tip point at each other and are spaced from each other by a dimension less than a maximum lateral dimension of said first and second adhesion material portions;
recessing portions of said top surface of said substrate employing at least said first adhesion material portion and said second adhesion material portion as an etch mask, wherein a first post contacting a bottom surface of said first adhesion material portion is formed from a remaining upper portion of said substrate and a second post contacting a bottom surface of said second adhesion material portion is formed from another remaining upper portion of said substrate, and a recessed top surface of said substrate is vertically separated from said bottom surfaces of said first adhesion material portion and said second adhesion material portion; and
depositing a metal on a top surface of said first adhesion material portion and on a top surface of said second adhesion material portion, wherein a first metallic pad is formed on said top surface of said first adhesion material portion and a second metallic pad is formed on said top surface of said second adhesion material portion.

12. The method of claim 11, wherein said metal comprises a noble metal.

13. The method of claim 11, wherein said first adhesion material portion has a first generally triangular horizontal cross-sectional shape, said first pointed tip is located at an apex of said first generally triangular horizontal cross-sectional shape, said second adhesion material portion has a second generally triangular horizontal cross-sectional shape, and said second pointed tip is located at an apex of said second generally triangular horizontal cross-sectional shape.

14. The method of claim 11, wherein said first adhesion material portion has a first generally elliptical horizontal cross-sectional shape, said first pointed tip is located at a vertex on a major axis of said first generally elliptical horizontal cross-sectional shape, said second adhesion material portion has a second generally elliptical horizontal cross-sectional shape, and said second pointed tip is located at a vertex on a major axis of said second generally elliptical horizontal cross-sectional shape.

15. The method of claim 11, further comprising:
depositing a metal layer comprising said metal on said recessed top surface of said substrate concurrently with said deposition of said metal on said top surface of said first adhesion material portion and on said top surface of said second adhesion material portion; and
removing said metal layer selective to said first metallic pad and said second metallic pad.

16. The method of claim 11, further comprising etching a material of said substrate from underneath peripheral portions of said first adhesion material portion and from underneath peripheral portions of said second adhesion material portion.

17. The method of claim 11, wherein sidewalls of said first post are laterally recessed from sidewalls of said first adhesion material portion by a first lateral offset distance by said etching, and sidewalls of said second post are laterally recessed from sidewalls of said second adhesion material portion by a second lateral offset distance by said etching.

18. The method of claim 17, wherein said first lateral offset distance and said second lateral offset distance are the same as measured at a same horizontal plane that intersects said first and second posts.

19. The method of claim 11, wherein each of said first metallic pad and said second metallic pad are formed with a substantially same horizontal cross-sectional area between a topmost surface thereof and a bottommost surface thereof.

20. The method of claim 19, further comprising forming additional first adhesion material portions and additional second adhesion material portion on said top surface of said substrate, wherein said first adhesion material portion, said additional adhesion material portion, said second adhesion material portion, and said second additional adhesion material portion are formed as a two-dimensional array, wherein said portions of said top surface of said substrate are recessed employing said first adhesion material portion, said additional first adhesion material portions, said second adhesion material portion, and said additional second adhesion material portions as an etch mask, wherein said two-dimensional array is a periodic array having a first pitch along a first horizontal direction and having a second pitch along a second horizontal direction, wherein each of said first pitch and said second pitch is in a range from 50 nm to 5,000 nm.
